(19) United States
(12) Patent Application Publication
(10) Pub. No.: US 2025/0102364 A1
(43) Pub. Date: Mar. 27, 2025

(54) BROADBAND ELECTRICAL SUBSTITUTION RADIOMETER, ARRAY OF SAME, AND PERFORMING RADIOMETRY

(71) Applicant: Government of the United States of America, as represented by the Secretary of Commerce, Gaithersburg, MD (US)

(72) Inventors: Christopher Shing-Yu Yung, Louisville, CO (US); Nathan Andrew Tomlin, Boulder, CO (US); Cameron Joseph Edgar Straatsma, Louisville, CO (US); David Murray Harber, Louisville, CO (US)

(21) Appl. No.: 18/891,767

(22) Filed: Sep. 20, 2024

Related U.S. Application Data
(60) Provisional application No. 63/539,632, filed on Sep. 21, 2023.

(51) Int. Cl. G01J 5/20

(52) U.S. Cl. CPC G01J 5/20

(57) ABSTRACT

A broadband electrical substitution radiometer includes a substrate, an isolation layer disposed on the substrate, an electrical thermometer-heater disposed on the isolation layer, an electrical lead in electrical communication with the electrical thermometer-heater, selective removal of the substrate to form a suspended isolation layer, and an optical absorber disposed on the isolation layer. The isolation layer comprises a thermal isolation platform, a thermal isolation support beam, and a thermal isolation island. The electrical thermometer-heater is disposed on the thermal isolation island and detects a change in temperature and controllably heats the isolation layer. The electrical lead receives a signal from and provides power to the electrical thermometer-heater. The optical absorber absorbs radiation incident on the radiometer.

### CROSS REFERENCE TO RELATED APPLICATIONS

This application claims the benefit of U.S. Provisional Patent Application Ser. No. 63/539,632 (filed Sep. 21, 2023), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BACKGROUND

The present invention generally relates to the field of broadband electrical substitution radiometers, and more particularly to techniques for performing absolute radiometry for a broad range of wavelengths.

Conventional bolometers, including microbolometers, are thermal detectors of infrared radiation. They typically comprise a thermally isolated absorber that heats in response to the absorption of radiation. A thermistor, in thermal communication with the absorber, registers a change in temperature by a change in its electrical resistance. The change in resistance, in turn, is converted to an electrical signal. Conventional bolometers do not measure the power incident directly; however, they can be used as power meters by calibrating against a source of known irradiance.

Conventional microbolometers, an array of microscopic bolometer elements, are used in infrared imaging; however, their spectral response is narrowband due to their use of a resonant absorber. To efficiently absorb incident radiation, this absorber is placed a quarter wavelength (λ/4) above a reflector (typically a metal layer for high reflectance). Peak absorptance is centered at λ, and the absorptance falls off quickly for wavelengths other than λ, and is therefore not broadband. Additionally, because conventional bolometers register only a temperature change when radiation is absorbed, the measured power is derived from either known physical properties of the bolometer or through calibration from an external radiation source of known irradiance (W/m²) or temperature (calibrated blackbody source).

Electrical substitution radiometers measure the power of incident radiation directly by using electrical power to produce a temperature rise in the detector equivalent to that produced by the absorbed radiation. This technique circumvents the need for calibration, as the absorbed power measurement is directly compared to an electrical power measurement. However, conventional electrical substitution radiometers are macroscopic (e.g., active cavity radiometers), and they utilize complex schemes for thermal isolation, temperature sensing, and electrical heating, making them unsuitable for miniaturization and integration into focal plane arrays.

It is, therefore, an objective of the present invention to provide a broadband electrical substitution radiometer that can be miniaturized and integrated into arrays, thereby overcoming the above-mentioned disadvantages of the prior art at least in part. Accordingly, methods and equipment for using broadband, miniature electrical substitution radiometers would be advantageous and would be favorably received in the art.

### BRIEF DESCRIPTION

One aspect of the present invention relates to a broadband electrical substitution radiometer. A broadband electrical substitution radiometer may be understood as an instrument for measuring the power of incident radiation over a broad range of wavelengths. It may be provided that the broadband electrical substitution radiometer comprises a substrate. A substrate may be understood as a structural member for providing support of other elements. One advantage of this arrangement is that it provides a platform upon which the isolation layer can be disposed. It may be provided that the broadband electrical substitution radiometer comprises an isolation layer disposed on the substrate. An isolation layer may be understood as a layer that limits or prevents transfer of heat or electric charge. One advantage of this arrangement is that it limits unwanted heat transfer between the substrate and the electrical thermometer-heater, thereby increasing the sensitivity of the broadband electrical substitution radiometer. It may be provided that the broadband electrical substitution radiometer comprises a thermal isolation platform. One advantage of this arrangement is that it provides structural support for the thermal isolation support beam. It may be provided that the broadband electrical substitution radiometer comprises a thermal isolation support beam. A thermal isolation support beam may be understood as a structural member for supporting the thermal isolation island. One advantage of this arrangement is that it supports the thermal isolation island in spaced relation from the thermal isolation platform, thus further limiting unwanted heat transfer. It may be provided that the broadband electrical substitution radiometer comprises a thermal isolation island. One advantage of this arrangement is that it provides structural support for the electrical thermometer-heater and the optical absorber. It may be provided that the broadband electrical substitution radiometer comprises an electrical thermometer-heater disposed on the thermal isolation island. One advantage of this arrangement is that it detects a change in temperature of the thermal isolation island when the optical absorber absorbs incident radiation, thus providing a measure of incident radiation power. One advantage of this arrangement is that it heats the thermal isolation island using electrical power, thus providing a means of calibrating the broadband electrical substitution radiometer. It may be provided that the broadband electrical substitution radiometer comprises an electrical lead in electrical communication with the electrical thermometer-heater. An electrical lead may be understood as a conductive path for transmitting an electrical signal or power. One advantage of this arrangement is that it receives the temperature signal from the electrical thermometer-heater and provides electrical power to the electrical thermometer-heater. It may be provided that the broadband electrical substitution radiometer comprises an optical absorber disposed on the thermal isolation island for absorbing radiation incident on the broadband electrical substitution radiometer. One advantage of this arrangement is that it absorbs radiation over a broad range of wavelengths, thus enabling broadband operation of the broadband electrical substitution radiometer.

One aspect of the present invention relates to a broadband electrical substitution radiometer array. A broadband electrical substitution radiometer array may be understood as a collection of broadband electrical substitution radiometers configured to operate as a unit. It may be provided that the broadband electrical substitution radiometer array comprises a plurality of broadband electrical substitution radiometers. One advantage of this arrangement is that it enables the broadband electrical substitution radiometer array to sense radiation at multiple locations simultaneously. It may be provided that the plurality of broadband electrical substitution radiometers are arranged in a linear array. A linear array may be understood as a configuration in which elements are arranged along a line. One advantage of this arrangement is that it enables the broadband electrical substitution radiometer array to be used in push-broom imaging systems.

One aspect of the present invention relates to a process for performing electrical substitution radiometry with a broadband electrical substitution radiometer. Electrical substitution radiometry may be understood as a technique for measuring the power of incident radiation by comparing the temperature rise induced by the absorbed radiation to an equivalent temperature rise induced by electrical heating. It may be provided that the process comprises providing the broadband electrical substitution radiometer. One advantage of this arrangement is that it utilizes an instrument that absorbs radiation over a broad range of wavelengths and that uses an electrical thermometer-heater for both sensing temperature and for controllable heating. It may be provided that the process comprises exposing the broadband electrical substitution radiometer to radiation. One advantage of this arrangement is that it allows for incident radiation to be absorbed by the optical absorber. It may be provided that the process comprises electrically heating the electrical thermometer-heater to a first temperature. One advantage of this arrangement is that it establishes a baseline temperature for the thermal isolation island. It may be provided that the process comprises detecting a change in temperature of the electrical thermometer-heater in response to the radiation. One advantage of this arrangement is that it provides a measure of the incident radiation power. It may be provided that the process comprises adjusting electrical power provided to the electrical thermometer-heater to maintain the first temperature. One advantage of this arrangement is that the adjusted electrical power is a direct measure of the incident radiation power.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, a cross-section of a broadband electrical substitution radiometer.

FIG. 2 shows, according to some embodiments, a cross-section of a broadband electrical substitution radiometer.

FIG. 3 shows, according to some embodiments, a cross-section of a broadband electrical substitution radiometer.

FIG. 4 shows, according to some embodiments, a perspective view of a broadband electrical substitution radiometer.

FIG. 5 shows, according to some embodiments, a perspective view (top panel) and a cross-sectional view (bottom panel) of a broadband electrical substitution radiometer.

FIG. 6 shows, according to some embodiments, a plan view of an array of broadband electrical substitution radiometers. This figure is an optical image of the backside of the pixels in the microbolometer array showing the Pt thermistors/heaters.

FIG. 7 shows, according to some embodiments, a plan view of an array of broadband electrical substitution radiometers. This figure is a scanning electron microscope image of the frontside of the pixels showing vertically aligned carbon nanotubes (≈20 μm tall) on each pixel.

FIG. 8 shows, according to some embodiments, a plan view of an array of broadband electrical substitution radiometers. The top panel is a view of the detector chip, and the bottom panel is a zoomed view of a plurality of broadband electrical substitution radiometers arranged in the linear array.

FIG. 9 shows, according to some embodiments, an electronics configuration for operating a broadband electrical substitution radiometer.

FIG. 10 shows, according to some embodiments, data acquired from a broadband electrical substitution radiometer using the electronics configuration shown in FIG. 9.

FIG. 11 shows, according to some embodiments, measured pixel (broadband electrical substitution radiometer of an array) performance for two different replacement powers. The blue line is for a replacement power of 10 μW (corresponding to a 5° C. temperature rise) with a noise floor of ≈100 pW/√Hz. The orange line is for a replacement power of 88 μW (corresponding to a 45° C. temperature rise) with a noise floor of ≈40 pW/√Hz.

FIG. 12 shows, according to some embodiments, (top panel) a crosstalk for a broadband electrical substitution radiometer illuminated with light on the left and an adjacent broadband electrical substitution radiometer that is not illuminated; and (bottom panel) the corresponding power noise density versus frequency for each broadband electrical substitution radiometer.

### DETAILED DESCRIPTION

A detailed description of one or more embodiments is presented herein by way of exemplification and not limitation.

Conventional bolometers, including microbolometers, typically use a resonant absorber for radiation absorption; however, this limits the spectral response to a narrow band of wavelengths. Additionally, typical bolometers do not measure the power incident directly, but instead use either known physical properties or calibration against a known source.

The broadband electrical substitution radiometer overcomes these limitations by utilizing a broadband absorber for radiation absorption and by measuring incident power directly. It has been discovered that a broadband electrical substitution radiometer can provide for broadband absolute radiometry by employing a broadband absorber, such as vertically aligned carbon nanotubes, and by placing the electrical thermometer-heater in one arm of a Wheatstone bridge. One advantage of this arrangement is that it simplifies fabrication, as only a single thin film element is needed for both sensing temperature and for electrical substitution. The isolation layer further increases the sensitivity by thermally and electrically isolating the electrical thermometer-heater from the substrate. The substrate provides structural support upon which the isolation layer can be disposed. The substrate is selectively removed to suspend the isolation layer to thermally isolate it. To further enhance thermal isolation, the thermal isolation support beam supports the thermal isolation island in spaced relation from the thermal isolation platform. The thermal isolation platform provides support for the thermal isolation support beam, and the thermal isolation island provides support for the electrical thermometer-heater and the optical absorber. One advantage of this arrangement is that it provides for isotropic heating of the electrical thermometer-heater by minimizing thermal gradients in the thermal isolation island. The electrical thermometer-heater provides a direct measure of the incident power by sensing the change in temperature when the optical absorber absorbs radiation and by adjusting the electrical power supplied to the electrical thermometer-heater to maintain a constant temperature. The electrical lead provides the means by which to receive the temperature signal from the electrical thermometer-heater, and it provides electrical power to the electrical thermometer-heater.

In an embodiment, a broadband electrical substitution radiometer 201 comprises: a substrate 214; an isolation layer 213 disposed on the substrate 214, the isolation layer 213 comprising a thermal isolation platform 203, a thermal isolation support beam 204, and a thermal isolation island 205; an electrical thermometer-heater 207 disposed on the thermal isolation island 205, the electrical thermometer-heater 207 for detecting a change in temperature of the thermal isolation island 205 and for controllably heating the thermal isolation island 205; an electrical lead 208 in electrical communication with the electrical thermometer-heater 207; and an optical absorber 206 disposed on the thermal isolation island 205 for absorbing radiation incident on the broadband electrical substitution radiometer 201. In an embodiment, the isolation layer 213 is silicon nitride. In an embodiment, the thermal isolation support beam 204 comprises legs that support the thermal isolation island 205. In an embodiment, the electrical thermometer-heater 207 is a platinum thin film. In an embodiment, the electrical thermometer-heater 207 is a metal oxide thermistor. In an embodiment, the broadband electrical substitution radiometer 201 further comprises a diffusion barrier 211 disposed on the thermal isolation island 205, the diffusion barrier 211 interposed between the electrical thermometer-heater 207 and the optical absorber 206. In an embodiment, the optical absorber 206 is vertically aligned carbon nanotubes. In an embodiment, the broadband electrical substitution radiometer 201 further comprises a support catalyst 210 disposed on the thermal isolation island 205, the support catalyst 210 interposed between the optical absorber 206 and the thermal isolation island 205. In an embodiment, the broadband electrical substitution radiometer 201 of further comprises a catalyst layer 209 disposed on the thermal isolation island 205, the catalyst layer 209 interposed between the support catalyst 210 and the optical absorber 206. In an embodiment, the substrate 214 comprises a silicon substrate 214.

The broadband electrical substitution radiometer 201 includes a substrate 214 that provides structural support for the other elements. The substrate 214 may be fabricated from a material such as silicon. An isolation layer 213 is disposed on the substrate 214. The isolation layer 213 serves to both thermally and electrically isolate the electrical thermometer-heater 207 from the substrate 214. The isolation layer 213 may be fabricated from a material such as silicon nitride and may be deposited by low-pressure chemical vapor deposition. The isolation layer 213 is patterned to define the thermal isolation platform 203, the thermal isolation support beam 204, and the thermal isolation island 205. The patterning may be accomplished using photolithography and etching. The thermal isolation platform 203 provides support for the thermal isolation support beam 204. The thermal isolation support beam 204 provides support for the thermal isolation island 205. The thermal isolation support beam 204 may comprise legs that support the thermal isolation island 205 in spaced relation from the thermal isolation platform 203. The thermal isolation island 205 provides support for the electrical thermometer-heater 207 and the optical absorber 206. The electrical thermometer-heater 207 is disposed on the thermal isolation island 205. The electrical thermometer-heater 207 is used to detect a change in the temperature of the thermal isolation island 205 and to controllably heat the thermal isolation island 205. The electrical thermometer-heater 207 may be implemented as either a platinum thin film or a metal oxide thermistor. The electrical thermometer-heater 207 may be patterned using photolithography and etching. The electrical lead 208 is deposited on the isolation layer 213. The electrical lead 208 is in electrical communication with the electrical thermometer-heater 207. The electrical lead 208 is used to receive the temperature signal from the electrical thermometer-heater 207 and to provide electrical power to the electrical thermometer-heater 207. The electrical lead 208 may be fabricated from a material such as platinum and may be deposited by sputtering. An optical absorber 206 is deposited on the thermal isolation island 205. The optical absorber 206 absorbs radiation incident on the broadband electrical substitution radiometer 201. The optical absorber 206 may be implemented as vertically aligned carbon nanotubes and may be deposited using chemical vapor deposition.

The substrate 214 provides structural support for the isolation layer 213. The isolation layer 213 limits unwanted heat and electrical transfer between the substrate 214 and the electrical thermometer-heater 207. Patterning of the isolation layer 213 provides for the thermal isolation platform 203, the thermal isolation support beam 204, and the thermal isolation island 205. The thermal isolation platform 203 supports the thermal isolation support beam 204. The thermal isolation support beam 204 provides support for the thermal isolation island 205 in spaced relation from the thermal isolation platform 203 to limit unwanted heat transfer. The thermal isolation island 205 provides support for the electrical thermometer-heater 207 and the optical absorber 206. The electrical thermometer-heater 207 senses changes in temperature and provides controllable heating. The electrical lead 208 provides electrical communication and power to the electrical thermometer-heater 207, and the optical absorber 206 provides for broadband absorption of incident radiation.

The isolation layer 213 may be silicon nitride. The isolation layer 213 may be deposited using low-pressure chemical vapor deposition. The thermal isolation support beam 204 may comprise four legs. The legs may be formed by patterning the isolation layer 213. Patterning of the isolation layer 213 may be accomplished using photolithography and etching. The electrical thermometer-heater 207 may be a platinum thin film. Platinum is deposited by sputtering and patterned to form the electrical thermometer-heater 207. The electrical thermometer-heater 207 may be a metal oxide thermistor. The metal oxide thermistor material is deposited by sputtering and patterned to form the electrical thermometer-heater 207. The broadband electrical substitution radiometer 201 may further comprise a diffusion barrier 211. The diffusion barrier 211 is disposed on the thermal isolation island 205 and is interposed between the electrical thermometer-heater 207 and the optical absorber 206. The diffusion barrier 211 may be, for example, aluminum oxide and deposited using sputtering. The optical absorber 206 may be implemented as vertically aligned carbon nanotubes. The vertically aligned carbon nanotubes are deposited by chemical vapor deposition on the thermal isolation island 205. A support catalyst 210 may be disposed on the thermal isolation island 205 and deposited using sputtering. The support catalyst 210 is interposed between the optical absorber 206 and the thermal isolation island 205. A catalyst layer 209 may be disposed on the thermal isolation island 205 and deposited using sputtering. The catalyst layer 209 is interposed between the support catalyst 210 and the optical absorber 206. The substrate 214 may be a silicon substrate 214.

Use of silicon nitride for the isolation layer 213 provides excellent thermal and electrical isolation properties. The use of low-pressure chemical vapor deposition allows for uniform deposition of silicon nitride. Using four legs for the thermal isolation support beam 204 enhances thermal isolation by minimizing thermal conduction. Photolithography and etching are well-established techniques for patterning thin films with high resolution. Employing a platinum thin film for the electrical thermometer-heater 207 provides a stable temperature sensor with good linearity. Sputtering is a suitable method for depositing thin platinum films. Alternatively, a metal oxide thermistor may be used for the electrical thermometer-heater 207, and these materials are also readily deposited by sputtering. A diffusion barrier 211 further improves device performance by limiting diffusion between the electrical thermometer-heater 207 and the optical absorber 206 and is readily deposited by sputtering. The use of vertically aligned carbon nanotubes for the optical absorber 206 provides near-unity absorptance over a wide range of wavelengths, extending from the ultraviolet through the far-infrared. Chemical vapor deposition is a suitable method for depositing vertically aligned carbon nanotubes, and the addition of a support catalyst 210, and a catalyst layer 209, can further improve the quality of the vertically aligned carbon nanotubes. Silicon is a widely available, low-cost material well suited for use as the substrate 214.

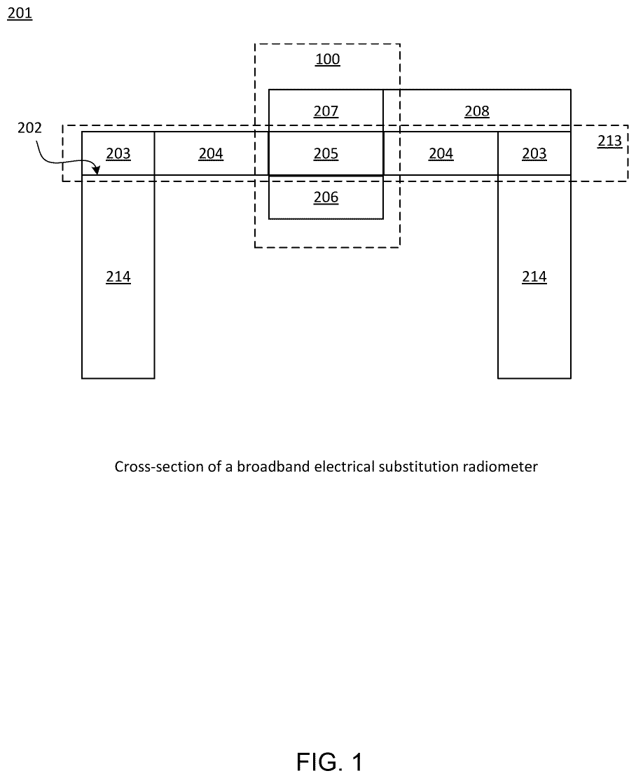

FIG. 1 shows a cross-section of a broadband electrical substitution radiometer 201. The broadband electrical substitution radiometer 201 includes a substrate 214 upon which an isolation layer 213 is disposed. The isolation layer 213 includes a thermal isolation platform 203, a thermal isolation support beam 204, and a thermal isolation island 205. The thermal isolation island 205 supports an optical absorber 206 and an electrical thermometer-heater 207. The electrical thermometer-heater 207 is in electrical communication with an electrical lead 208. The substrate 214 provides a surface 202 on which is disposed the isolation layer 213. The isolation layer 213 thermally and electrically isolates the thermal isolation island 205 from the substrate 214. The isolation layer 213 may be a material such as silicon nitride. The isolation layer 213 may be deposited by a process such as low-pressure chemical vapor deposition. The thermal isolation platform 203 is a contiguous portion of the isolation layer 213 and is in contact with the substrate 214. The thermal isolation support beam 204 is a portion of the isolation layer 213 and is disposed on the thermal isolation platform 203. The thermal isolation support beam 204 supports the thermal isolation island 205 and may be implemented as, for example, four legs. The thermal isolation island 205 is also a portion of the isolation layer 213 and is supported by the thermal isolation support beam 204. The optical absorber 206 may be a material such as vertically aligned carbon nanotubes. The vertically aligned carbon nanotubes may be deposited on the thermal isolation island 205 by a process such as chemical vapor deposition. The electrical thermometer-heater 207 is disposed on the thermal isolation island 205 and may be, for example, a platinum thin film. The platinum thin film may be deposited by a process such as sputtering. The electrical lead 208 is disposed on the isolation layer 213. The electrical lead 208 may be a material such as platinum and may be deposited by sputtering. The substrate 214 may be a material such as silicon.

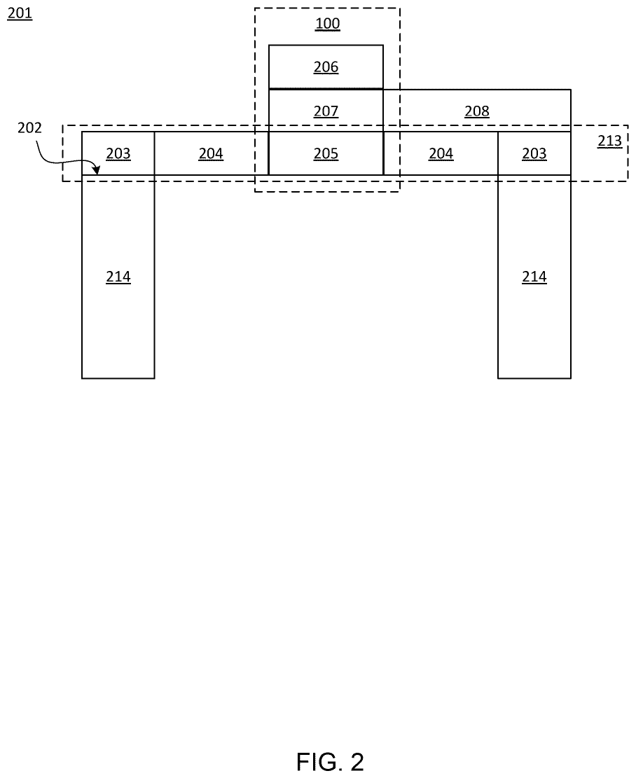

FIG. 2 shows a cross-section of a broadband electrical substitution radiometer 201 that is similar to that shown in FIG. 1, except for the position of the optical absorber 206 relative to the electrical thermometer-heater 207. The broadband electrical substitution radiometer 201 includes a substrate 214 upon which is disposed an isolation layer 213. The isolation layer 213 comprises a thermal isolation platform 203, a thermal isolation support beam 204, and a thermal isolation island 205. An electrical thermometer-heater 207 and an optical absorber 206 are disposed on the thermal isolation island 205. The electrical thermometer-heater 207 is in electrical communication with an electrical lead 208. The substrate 214 provides a surface 202 on which is disposed the isolation layer 213. The isolation layer 213 thermally and electrically isolates the thermal isolation island 205 from the substrate 214. The isolation layer 213 may be a material such as silicon nitride. The isolation layer 213 may be deposited by a process such as low-pressure chemical vapor deposition. The thermal isolation platform 203 is a contiguous portion of the isolation layer 213 and is in contact with the substrate 214. The thermal isolation support beam 204 is a portion of the isolation layer 213 and is disposed on the thermal isolation platform 203. The thermal isolation support beam 204 supports the thermal isolation island 205 and may be implemented as, for example, four legs. The thermal isolation island 205 is a portion of the isolation layer 213 and is supported by the thermal isolation support beam 204. The electrical thermometer-heater 207 is disposed on the thermal isolation island 205 and may be, for example, a platinum thin film. The platinum thin film may be deposited by a process such as sputtering. The electrical lead 208 is disposed on the isolation layer 213. The electrical lead 208 may be a material such as platinum and may be deposited by sputtering. The optical absorber 206 is disposed on the thermal isolation island 205 such that the optical absorber 206 is disposed between the electrical thermometer-heater 207 and the thermal isolation support beam 204. The optical absorber 206 may be a material such as vertically aligned carbon nanotubes. The vertically aligned carbon nanotubes may be deposited by a process such as chemical vapor deposition. The substrate 214 may be a material such as silicon.

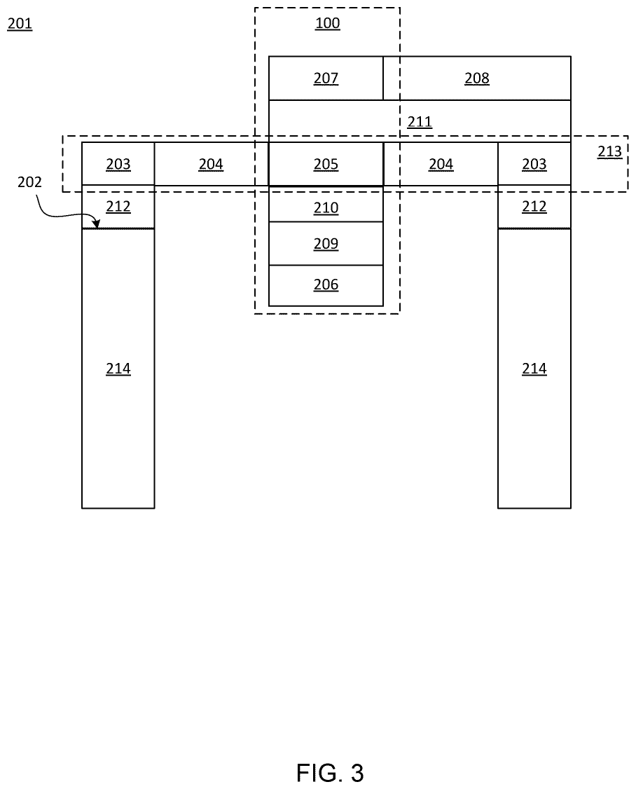

FIG. 3 shows a cross-section of a broadband electrical substitution radiometer 201 that is similar to that shown in FIG. 1 but includes an etch stop layer 212, a diffusion barrier 211, a support catalyst 210, and a catalyst layer 209. The broadband electrical substitution radiometer 201 includes a substrate 214 that provides a surface 202. An etch stop layer 212 is disposed on the surface 202. An isolation layer 213 is disposed on the etch stop layer 212. The isolation layer 213 comprises a thermal isolation platform 203, a thermal isolation support beam 204, and a thermal isolation island 205. A support catalyst 210 and a catalyst layer 209 are disposed on the thermal isolation island 205. An optical absorber 206 is disposed on the catalyst layer 209. A diffusion barrier 211 is disposed on the thermal isolation island 205. An electrical thermometer-heater 207 is disposed on the diffusion barrier 211. The electrical thermometer-heater 207 is in electrical communication with an electrical lead 208. The etch stop layer 212 may be implemented, for example, using silicon oxide. The isolation layer 213 thermally and electrically isolates the thermal isolation island 205 from the substrate 214. The isolation layer 213 may be a material such as silicon nitride. The isolation layer 213 may be deposited by a process such as low-pressure chemical vapor deposition. The thermal isolation platform 203 is a contiguous portion of the isolation layer 213 and is in contact with the etch stop layer 212. The thermal isolation support beam 204 is a portion of the isolation layer 213 and is disposed on the thermal isolation platform 203. The thermal isolation support beam 204 supports the thermal isolation island 205 and may be implemented as, for example, four legs. The thermal isolation island 205 is also a portion of the isolation layer 213 and is supported by the thermal isolation support beam 204. The support catalyst 210 is disposed on the thermal isolation island 205. The support catalyst 210 may be implemented using a material such as aluminum oxide and may be deposited by a process such as sputtering. The catalyst layer 209 is disposed on the support catalyst 210. The catalyst layer 209 may be implemented using a material such as iron, cobalt, or nickel and may be deposited by a process such as sputtering. The optical absorber 206 is disposed on the catalyst layer 209. The optical absorber 206 may be a material such as vertically aligned carbon nanotubes. The vertically aligned carbon nanotubes may be deposited by a process such as chemical vapor deposition. The diffusion barrier 211 is disposed on the thermal isolation island 205. The diffusion barrier 211 may be implemented using a material such as aluminum oxide and may be deposited by a process such as sputtering. The electrical thermometer-heater 207 is disposed on the diffusion barrier 211 and may be, for example, a platinum thin film. The platinum thin film may be deposited by a process such as sputtering. The electrical lead 208 is disposed on the isolation layer 213. The electrical lead 208 may be a material such as platinum and may be deposited by sputtering. The substrate 214 may be a material such as silicon.

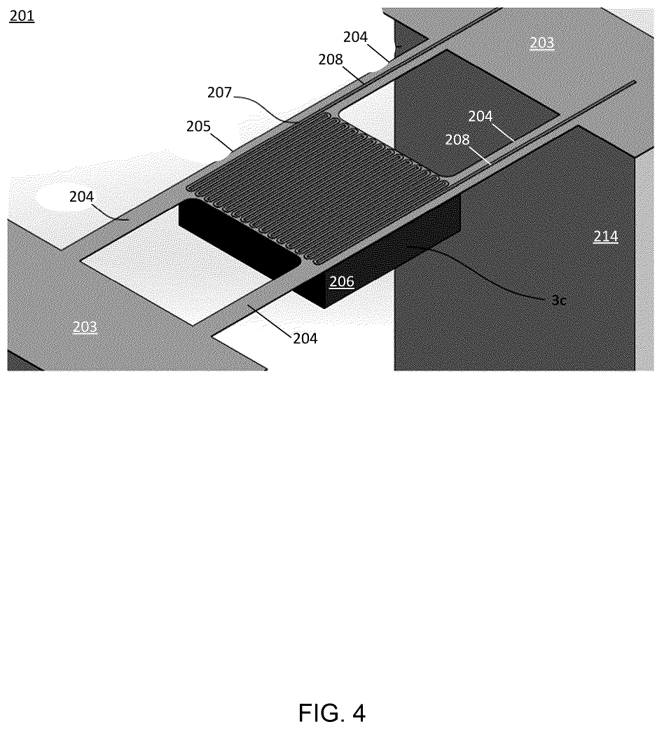

FIG. 4 shows a perspective view of a broadband electrical substitution radiometer 201 that is similar to that shown in FIG. 1, wherein the thermal isolation support beam 204 includes four legs that interconnect the thermal isolation platform 203 to the thermal isolation island 205. The broadband electrical substitution radiometer 201 includes a substrate 214 upon which is disposed an isolation layer 213. The isolation layer 213 includes a thermal isolation platform 203, a thermal isolation support beam 204, and a thermal isolation island 205. The thermal isolation support beam 204 comprises four legs that support the thermal isolation island 205. An optical absorber 206 is disposed on the thermal isolation island 205, which is also supported by the thermal isolation support beam 204. An electrical thermometer-heater 207 is disposed on the thermal isolation island 205. The electrical thermometer-heater 207 is in electrical communication with electrical leads 208. The substrate 214 may be implemented, for example, using silicon. The substrate 214 provides a surface 202 upon which the isolation layer 213 is disposed. The isolation layer 213 thermally and electrically isolates the thermal isolation island 205 from the substrate 214. The isolation layer 213 may be a material such as silicon nitride. The isolation layer 213 may be deposited by a process such as low-pressure chemical vapor deposition. The thermal isolation platform 203 is a contiguous portion of the isolation layer 213 and is in contact with the substrate 214. The thermal isolation support beam 204 is a portion of the isolation layer 213 and is disposed on the thermal isolation platform 203. The thermal isolation support beam 204 comprises four legs that extend outward and in-plane from the thermal isolation island 205 to the thermal isolation platform 203. The thermal isolation support beam 204 minimizes the amount of thermal conduction between the thermal isolation island 205 and the thermal isolation platform 203. The thermal isolation island 205 is a portion of the isolation layer 213 and is supported by the thermal isolation support beam 204. The optical absorber 206 is disposed on the thermal isolation island 205. The optical absorber 206 may be a material such as vertically aligned carbon nanotubes. The vertically aligned carbon nanotubes may be deposited by a process such as chemical vapor deposition. The electrical thermometer-heater 207 is disposed on the thermal isolation island 205. The electrical thermometer-heater 207 comprises a plurality of parallel conductive traces that are connected at one end to one of the electrical leads 208, and at the other end to the other of the electrical leads 208. The electrical thermometer-heater 207 may be a material such as a platinum thin film. The platinum thin film may be deposited by a process such as sputtering.

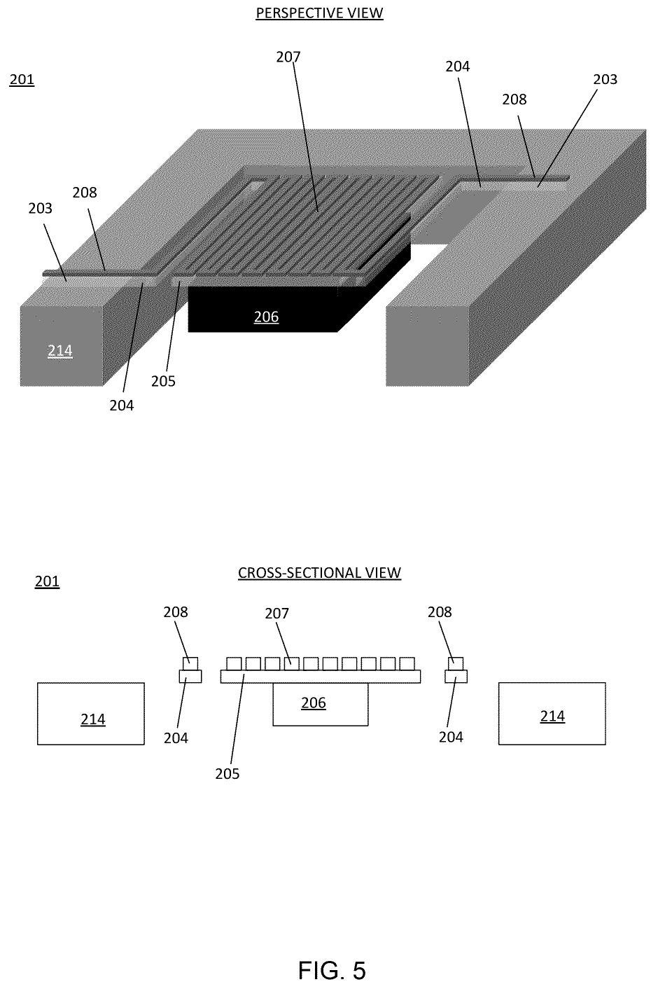

FIG. 5 shows a perspective view (top panel) and a cross-sectional view (bottom panel) of a broadband electrical substitution radiometer 201. The top panel of FIG. 5 shows the broadband electrical substitution radiometer 201 in perspective, looking down on the substrate 214. The bottom panel of FIG. 5 shows a cross-section of the broadband electrical substitution radiometer 201. The broadband electrical substitution radiometer 201 includes a substrate 214 upon which is disposed an isolation layer 213. The isolation layer 213 includes a thermal isolation platform 203, a thermal isolation support beam 204, and a thermal isolation island 205. The thermal isolation support beam 204 comprises four legs that support the thermal isolation island 205. An optical absorber 206 is disposed on the thermal isolation island 205, which is also supported by the thermal isolation support beam 204. An electrical thermometer-heater 207 is disposed on the thermal isolation island 205. The electrical thermometer-heater 207 is in electrical communication with electrical leads 208. The substrate 214 may be implemented, for example, using silicon. The substrate 214 provides a surface 202 upon which the isolation layer 213 is disposed. The isolation layer 213 thermally and electrically isolates the thermal isolation island 205 from the substrate 214. The isolation layer 213 may be a material such as silicon nitride. The isolation layer 213 may be deposited by a process such as low-pressure chemical vapor deposition. The thermal isolation platform 203 is a contiguous portion of the isolation layer 213 and is in contact with the substrate 214. The thermal isolation support beam 204 is a portion of the isolation layer 213 and is disposed on the thermal isolation platform 203. The thermal isolation support beam 204 comprises four legs that extend outward and in-plane from the thermal isolation island 205 to the thermal isolation platform 203. The thermal isolation support beam 204 minimizes the amount of thermal conduction between the thermal isolation island 205 and the thermal isolation platform 203. The thermal isolation island 205 is a portion of the isolation layer 213 and is supported by the thermal isolation support beam 204. The optical absorber 206 is disposed on the thermal isolation island 205. The optical absorber 206 may be a material such as vertically aligned carbon nanotubes. The vertically aligned carbon nanotubes may be deposited by a process such as chemical vapor deposition. The electrical thermometer-heater 207 is disposed on the thermal isolation island 205. The electrical thermometer-heater 207 is shown as a meander pattern that comprises a plurality of parallel conductive traces that are connected at one end to one of the electrical leads 208, and at the other end to the other of the electrical leads 208. The electrical thermometer-heater 207 may be a material such as a platinum thin film. The platinum thin film may be deposited by a process such as sputtering.

In an embodiment, a broadband electrical substitution radiometer array 200 comprises: a plurality of broadband electrical substitution radiometers 201, each broadband electrical substitution radiometer 201 comprising: a substrate 214; an isolation layer 213 disposed on the substrate 214, the isolation layer 213 comprising a thermal isolation platform 203, a thermal isolation support beam 204, and a thermal isolation island 205; an electrical thermometer-heater 207 disposed on the thermal isolation island 205, the electrical thermometer-heater 207 for detecting a change in temperature of the thermal isolation island 205 and for controllably heating the thermal isolation island 205; an electrical lead 208 in electrical communication with the electrical thermometer-heater 207; and an optical absorber 206 disposed on the thermal isolation island 205 for absorbing radiation incident on the broadband electrical substitution radiometer 201, wherein each of the plurality of broadband electrical substitution radiometers 201 are arranged in a linear array. In an embodiment, the isolation layer 213 is silicon nitride. In an embodiment, the thermal isolation support beam 204 comprises four legs that support the thermal isolation island 205. In an embodiment, the electrical thermometer-heater 207 is a platinum thin film. In an embodiment, the electrical thermometer-heater 207 is a metal oxide thermistor. In an embodiment, the broadband electrical substitution radiometer array 200 further comprises a diffusion barrier 211 disposed on the thermal isolation island 205, the diffusion barrier 211 interposed between the electrical thermometer-heater 207 and the optical absorber 206. In an embodiment, the optical absorber 206 is vertically aligned carbon nanotubes. In an embodiment, the broadband electrical substitution radiometer array 200 further comprises a support catalyst 210 disposed on the thermal isolation island 205, the support catalyst 210 interposed between the optical absorber 206 and the thermal isolation island 205. In an embodiment, the broadband electrical substitution radiometer array 200 further comprises a catalyst layer 209 disposed on the thermal isolation island 205, the catalyst layer 209 interposed between the support catalyst 210 and the optical absorber 206. In an embodiment, the substrate 214 comprises a silicon substrate 214.

The broadband electrical substitution radiometer array 200 is comprised of a plurality of broadband electrical substitution radiometers 201. Each broadband electrical substitution radiometer 201 comprises a substrate 214. The substrate 214 provides a structural platform for the broadband electrical substitution radiometer array 200 and may be a material such as silicon. An isolation layer 213 is disposed on the substrate 214 and thermally and electrically isolates the electrical thermometer-heater 207 from the substrate 214. The isolation layer 213 may be a material such as silicon nitride and deposited using a process such as low pressure chemical vapor deposition. The isolation layer 213 is patterned to define the thermal isolation platform 203, the thermal isolation support beam 204, and the thermal isolation island 205. The patterning may be accomplished by a combination of photolithography and etching. The thermal isolation platform 203 serves as a structural member for supporting the thermal isolation support beam 204. The thermal isolation support beam 204 supports the thermal isolation island 205. The thermal isolation support beam 204 may comprise four legs that support the thermal isolation island in a spaced relation from the thermal isolation platform 203. The thermal isolation island 205 supports the electrical thermometer-heater 207 and the optical absorber 206. The electrical thermometer-heater 207 is disposed on the thermal isolation island 205. The electrical thermometer-heater 207 detects a change in temperature when the optical absorber 206 absorbs incident radiation. The electrical thermometer-heater 207 controllably heats the thermal isolation island 205 using electrical power. The electrical thermometer-heater 207 may be implemented using a platinum thin film or a metal oxide thermistor. The electrical lead 208 is in electrical communication with the electrical thermometer-heater 207. The electrical lead 208 provides a means to receive the temperature signal from the electrical thermometer-heater 207 and to provide power to the electrical thermometer-heater 207. The optical absorber 206 is disposed on the thermal isolation island 205. The optical absorber 206 absorbs radiation over a broad band of wavelengths incident on the broadband electrical substitution radiometer 201. The optical absorber may be implemented using vertically aligned carbon nanotubes. Each of the broadband electrical substitution radiometers 201 are arranged in a linear array. The linear array allows for the broadband electrical substitution radiometer array 200 to be used in a push-broom imaging system.

The broadband electrical substitution radiometer array 200 is made up of multiple broadband electrical substitution radiometers 201, each of which include several elements. The substrate 214 provides structural support, and the isolation layer 213 limits heat transfer and electrical conduction. Patterning the isolation layer 213 enables the formation of the thermal isolation platform 203, the thermal isolation support beam 204, and the thermal isolation island 205. The thermal isolation platform 203 supports the thermal isolation support beam 204, and the thermal isolation support beam 204 supports the thermal isolation island 205 in spaced relation from the thermal isolation platform 203. This arrangement further enhances thermal isolation. The thermal isolation island 205 supports the electrical thermometer-heater 207 and the optical absorber 206. The electrical thermometer-heater 207 detects changes in temperature and enables temperature control using electrical power. The electrical lead 208 provides electrical communication and power to the electrical thermometer-heater, and the optical absorber 206 enables broadband absorption of radiation. Arranging the broadband electrical substitution radiometers 201 in a linear array allows for push-broom imaging.

The isolation layer 213 may be silicon nitride and deposited by low-pressure chemical vapor deposition to provide for excellent thermal and electrical isolation properties. The thermal isolation support beam 204 may be implemented as four legs. The four legs are formed by patterning the isolation layer 213 using a process such as photolithography and etching. The electrical thermometer-heater 207 may be a platinum thin film, deposited by sputtering and patterned using, for example, photolithography and etching. The electrical thermometer-heater 207 may be implemented as a metal oxide thermistor, deposited by a process such as sputtering and patterned by, for example, photolithography and etching. A diffusion barrier 211 may be deposited by sputtering on the thermal isolation island 205 and interposed between the electrical thermometer-heater 207 and the optical absorber 206 to limit diffusion. The diffusion barrier 211 may be a material such as aluminum oxide and deposited by sputtering. The optical absorber 206 may be implemented as vertically aligned carbon nanotubes and deposited using chemical vapor deposition to absorb radiation over a wide range of wavelengths. A support catalyst 210 may be disposed on the thermal isolation island 205 between the optical absorber 206 and the thermal isolation island 205 and deposited by sputtering. A catalyst layer 209 may be disposed on the thermal isolation island 205 and interposed between the support catalyst 210 and the optical absorber 206 and deposited by sputtering. The substrate 214 may be a silicon substrate 214.

Silicon nitride provides good thermal and electrical isolation, and low-pressure chemical vapor deposition produces a uniform deposition of silicon nitride. Fabricating the thermal isolation support beam 204 as legs minimizes thermal conduction. Platinum offers good temperature stability, and sputtering readily produces thin platinum films, while metal oxide thermistors offer an alternative implementation and are also readily deposited by sputtering. Employing a diffusion barrier 211 limits unwanted diffusion between the electrical thermometer-heater 207 and the thermal isolation island 205. Vertically aligned carbon nanotubes provide excellent broadband absorption of radiation, and chemical vapor deposition is a well-suited method for depositing vertically aligned carbon nanotubes. Using a support catalyst 210 and a catalyst layer 209 can facilitate growth of the vertically aligned carbon nanotubes. Silicon is a readily available, cost-effective material suitable for use as the substrate 214.

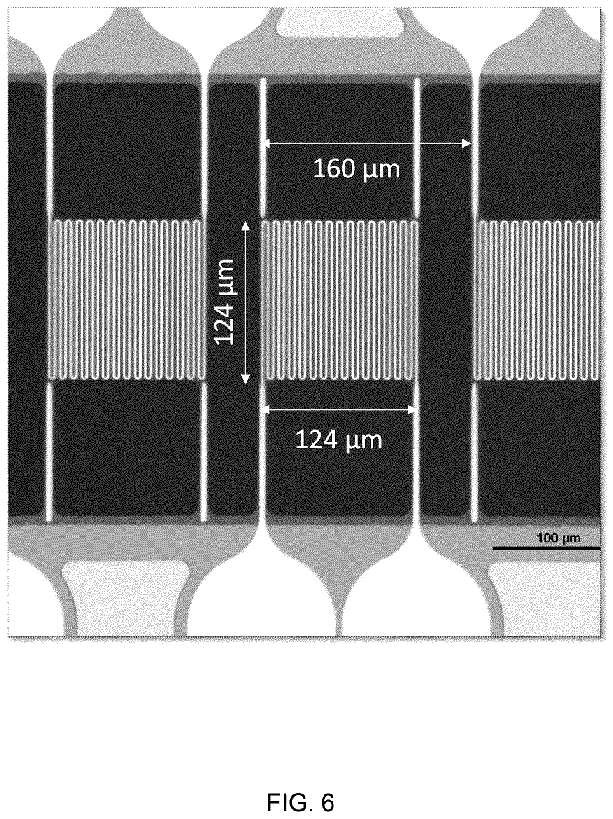

FIG. 6 shows a plan view of a broadband electrical substitution radiometer array 200, specifically an optical image of the backside of the broadband electrical substitution radiometers 201 in the array showing the Pt thermistors/heaters 207. Each broadband electrical substitution radiometer 201 comprises a substrate 214 upon which is disposed an isolation layer 213. The isolation layer 213 comprises a thermal isolation platform 203, a thermal isolation support beam 204, and a thermal isolation island 205. The thermal isolation support beam 204 comprises four legs that support the thermal isolation island 205. An electrical thermometer-heater 207 is disposed on the thermal isolation island 205, which is also supported by the thermal isolation support beam 204. The electrical thermometer-heater 207 is in electrical communication with electrical leads 208. The substrate 214 may be implemented, for example, using silicon. The substrate 214 provides a surface 202 upon which the isolation layer 213 is disposed. The isolation layer 213 thermally and electrically isolates the thermal isolation island 205 from the substrate 214. The isolation layer 213 may be a material such as silicon nitride. The isolation layer 213 may be deposited by a process such as low-pressure chemical vapor deposition. The thermal isolation platform 203 is a contiguous portion of the isolation layer 213 and is in contact with the substrate 214. The thermal isolation support beam 204 is a portion of the isolation layer 213 and is disposed on the thermal isolation platform 203. The thermal isolation support beam 204 comprises legs that extend downward from the thermal isolation island 205 to the thermal isolation platform 203. The thermal isolation support beam 204 minimizes the amount of thermal conduction between the thermal isolation island 205 and the thermal isolation platform 203. The thermal isolation island 205 is a portion of the isolation layer 213 and is supported by the thermal isolation support beam 204. The electrical thermometer-heater 207 is disposed on the thermal isolation island 205. The electrical thermometer-heater 207 comprises a plurality of parallel conductive traces that are connected at one end to one of the electrical leads 208, and at the other end to the other of the electrical leads 208. The electrical thermometer-heater 207 may be a material such as a platinum thin film. The platinum thin film may be deposited by a process such as sputtering. The electrical thermometer-heater 207 is visible in FIG. 6 because it is on the opposite side of the substrate 214 relative to the optical absorber 206. Each broadband electrical substitution radiometer 201 is separated from its adjacent broadband electrical substitution radiometers 201 by a distance of 160 μm. The linear array of broadband electrical substitution radiometers 201 extends along a line. The broadband electrical substitution radiometers 201 are electrically isolated from each other. The plurality of broadband electrical substitution radiometers 201 are arranged in the linear array such that radiation incident on the array 200 is incident on the optical absorbers 206.

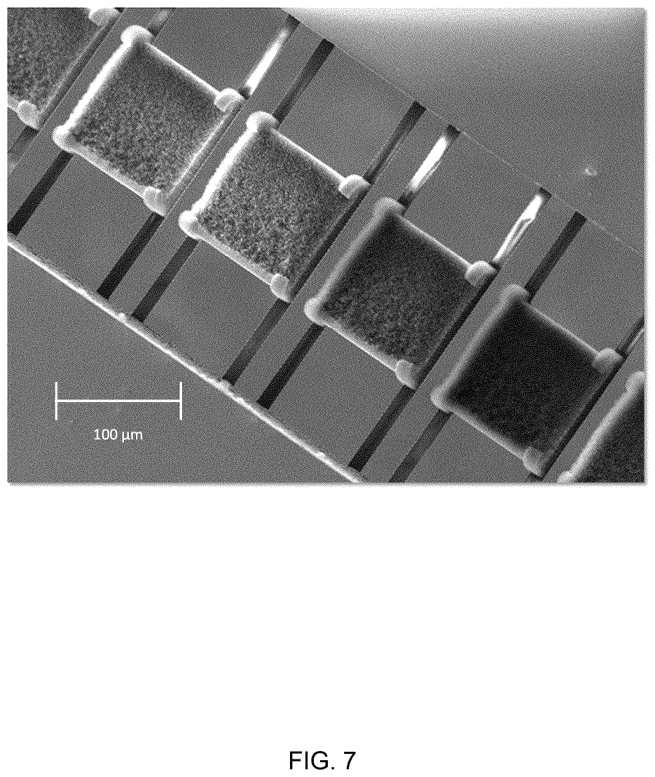

FIG. 7 shows a plan view of a broadband electrical substitution radiometer array 200, specifically a scanning electron microscope image of a portion of the array 200 showing vertically aligned carbon nanotubes 206 (≈20 μm tall) on each pixel or broadband electrical substitution radiometer 201. Each broadband electrical substitution radiometer 201 comprises a substrate 214 upon which is disposed an isolation layer 213. The isolation layer 213 comprises a thermal isolation platform 203, a thermal isolation support beam 204, and a thermal isolation island 205. The thermal isolation support beam 204 comprises four legs that support the thermal isolation island 205. An optical absorber 206 is disposed on the thermal isolation island 205, which is also supported by the thermal isolation support beam 204. An electrical thermometer-heater 207 is disposed on the thermal isolation island 205. The electrical thermometer-heater 207 is in electrical communication with electrical leads 208. The substrate 214 may be implemented, for example, using silicon. The substrate 214 provides a surface 202 upon which the isolation layer 213 is disposed. The isolation layer 213 thermally and electrically isolates the thermal isolation island 205 from the substrate 214. The isolation layer 213 may be a material such as silicon nitride. The isolation layer 213 may be deposited by a process such as low-pressure chemical vapor deposition. The thermal isolation platform 203 is a contiguous portion of the isolation layer 213 and is in contact with the substrate 214. The thermal isolation support beam 204 is a portion of the isolation layer 213 and is disposed on the thermal isolation platform 203. The thermal isolation support beam 204 comprises four legs that extend downward from the thermal isolation island 205 to the thermal isolation platform 203. The thermal isolation support beam 204 minimizes the amount of thermal conduction between the thermal isolation island 205 and the thermal isolation platform 203. The thermal isolation island 205 is a portion of the isolation layer 213 and is supported by the thermal isolation support beam 204. The optical absorber 206 is disposed on the thermal isolation island 205. The optical absorber 206 may be a material such as vertically aligned carbon nanotubes. The vertically aligned carbon nanotubes may be deposited by a process such as chemical vapor deposition. The vertically aligned carbon nanotubes 206 shown in FIG. 7 are approximately 20 μm in height. Each broadband electrical substitution radiometer 201 is separated from its adjacent broadband electrical substitution radiometers 201 by a distance of 160 μm. The linear array of broadband electrical substitution radiometers 201 extends along a line. The broadband electrical substitution radiometers 201 are electrically isolated from each other. The plurality of broadband electrical substitution radiometers 201 are arranged in the linear array such that radiation incident on the array 200 is incident on the optical absorbers 206.

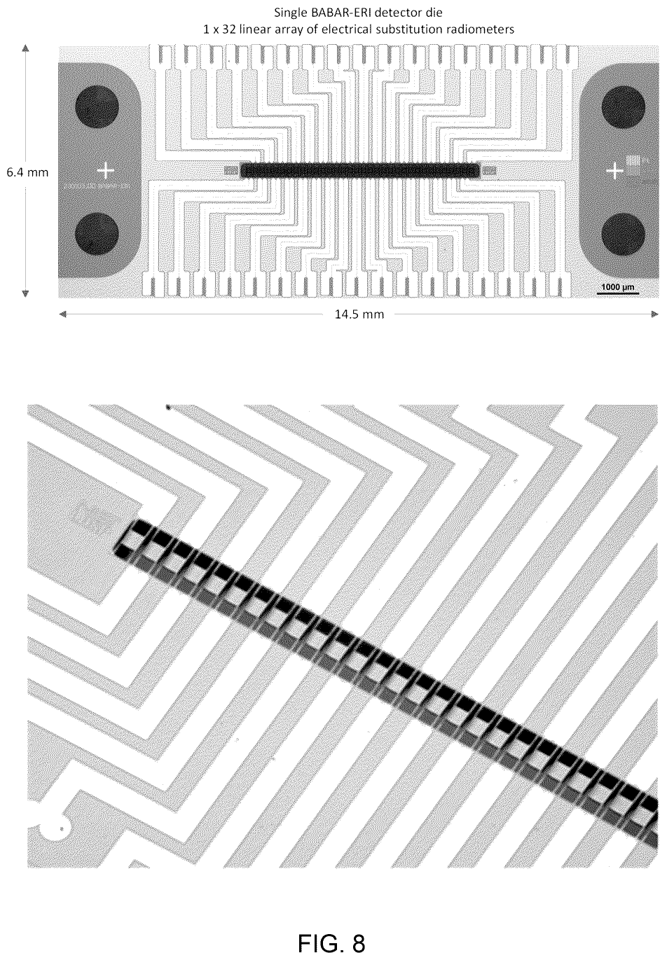

FIG. 8 shows a plan view of a broadband electrical substitution radiometer array 200. The top panel of FIG. 8 is a view of the entire detector chip, showing the linear array of broadband electrical substitution radiometers 201, and the bottom panel of FIG. 8 is a zoomed portion of the detector chip showing a plurality of individual broadband electrical substitution radiometers 201 arranged in the linear array. The detector chip shown in the top panel of FIG. 8 is 14.5 mm long and 6.4 mm wide. The linear array of broadband electrical substitution radiometers 201 extends across the length of the detector chip. Each broadband electrical substitution radiometer 201 comprises a substrate 214 upon which is disposed an isolation layer 213. The isolation layer 213 comprises a thermal isolation platform 203, a thermal isolation support beam 204, and a thermal isolation island 205. The thermal isolation support beam 204 comprises four legs that support the thermal isolation island 205. An optical absorber 206 is disposed on the thermal isolation island 205, which is also supported by the thermal isolation support beam 204. An electrical thermometer-heater 207 is disposed on the thermal isolation island 205. The electrical thermometer-heater 207 is in electrical communication with electrical leads 208. The substrate 214 may be implemented, for example, using silicon. The substrate 214 provides a surface 202 upon which the isolation layer 213 is disposed. The isolation layer 213 thermally and electrically isolates the thermal isolation island 205 from the substrate 214. The isolation layer 213 may be a material such as silicon nitride. The isolation layer 213 may be deposited by a process such as low-pressure chemical vapor deposition. The thermal isolation platform 203 is a contiguous portion of the isolation layer 213 and is in contact with the substrate 214. The thermal isolation support beam 204 is a portion of the isolation layer 213 and is disposed on the thermal isolation platform 203. The thermal isolation support beam 204 comprises four legs that extend downward from the thermal isolation island 205 to the thermal isolation platform 203. The thermal isolation support beam 204 minimizes the amount of thermal conduction between the thermal isolation island 205 and the thermal isolation platform 203. The thermal isolation island 205 is a portion of the isolation layer 213 and is supported by the thermal isolation support beam 204. The optical absorber 206 is disposed on the thermal isolation island 205. The optical absorber 206 may be a material such as vertically aligned carbon nanotubes. The vertically aligned carbon nanotubes may be deposited by a process such as chemical vapor deposition. The electrical thermometer-heater 207 is disposed on the thermal isolation island 205. The electrical thermometer-heater 207 comprises a plurality of parallel conductive traces that are connected at one end to one of the electrical leads 208, and at the other end to the other of the electrical leads 208. The electrical thermometer-heater 207 may be a material such as a platinum thin film. The platinum thin film may be deposited by a process such as sputtering. Each broadband electrical substitution radiometer 201 is separated from its adjacent broadband electrical substitution radiometers 201 by a distance of 160 μm. The linear array of broadband electrical substitution radiometers 201 extends along a line. The broadband electrical substitution radiometers 201 are electrically isolated from each other. The plurality of broadband electrical substitution radiometers 201 are arranged in the linear array such that radiation incident on the array 200 is incident on the optical absorbers 206.

Broadband electrical substitution radiometer array 200 can be made of various elements and components that are microfabricated.

The electrical substitution radiometer (ESR) island 100 is a component of the broadband electrical substitution radiometer 201. The ESR island 100 is formed from the thermal isolation island 205, the electrical thermometer-heater 207, and the optical absorber 206. The thermal isolation island 205 provides structural support for the electrical thermometer-heater 207 and the optical absorber 206. The electrical thermometer-heater 207 detects the change in temperature of the ESR island 100 when incident radiation is absorbed by the optical absorber 206. The electrical thermometer-heater 207 also provides for controllable heating of the ESR island 100 using electrical power. The optical absorber 206 absorbs incident radiation on the ESR island 100. The ESR island 100 enables broadband electrical substitution radiometry by minimizing thermal gradients, thus improving the accuracy of the power measurement. The thermal isolation island 205 provides structural support for the electrical thermometer-heater 207 and the optical absorber 206. The electrical thermometer-heater 207 senses temperature changes and enables controllable heating for absolute power measurements. The optical absorber 206 absorbs the incident radiation, enabling the ESR island 100 to respond to incident radiation.

The broadband electrical substitution radiometer 201 includes a substrate 214 that provides a planar surface 202 upon which other elements are disposed. Surface 202 of substrate 214 may be fabricated from silicon. The surface 202 provides a location for disposing the isolation layer 213. The surface 202 provides a planar location for disposing the isolation layer 213, thus ensuring uniformity in the thickness of the isolation layer 213.

The thermal isolation platform 203 of the broadband electrical substitution radiometer 201 is disposed on the substrate 214. The thermal isolation platform 203 provides support for the thermal isolation support beam 204 and is formed by patterning the isolation layer 213. The thermal isolation platform 203 may be a contiguous member of the isolation layer 213. The thermal isolation platform 203, being formed as a contiguous portion of the isolation layer 213, increases the thermal resistance between the substrate 214 and the thermal isolation support beam 204. This enhanced thermal isolation improves the sensitivity of the broadband electrical substitution radiometer 201.

The thermal isolation support beam 204 is disposed on the thermal isolation platform 203 and supports the thermal isolation island 205. The thermal isolation support beam 204 may be formed by patterning the isolation layer 213. The thermal isolation support beam 204 may comprise legs that support the thermal isolation island 205 in a spaced relationship from the thermal isolation platform 203. The thermal isolation support beam 204, being formed by patterning the isolation layer 213, enhances thermal isolation and, by employing four legs, further reduces thermal conduction between the thermal isolation platform 203 and the thermal isolation island 205.

The broadband electrical substitution radiometer 201 includes a thermal isolation island 205 disposed on the thermal isolation support beam 204. The thermal isolation island 205 provides support for the optical absorber 206 and the electrical thermometer-heater 207 and is formed from the isolation layer 213. The thermal isolation island 205, by supporting the optical absorber 206 and the electrical thermometer-heater 207, limits thermal gradients, thus enabling the broadband electrical substitution radiometer 201 to accurately measure the power of incident radiation.

The optical absorber 206 is disposed on the thermal isolation island 205 and absorbs radiation incident on the broadband electrical substitution radiometer 201. The optical absorber 206 can be implemented using vertically aligned carbon nanotubes and deposited using chemical vapor deposition. Vertically aligned carbon nanotubes provide near-unity absorption over a wide range of wavelengths, thus enabling the broadband electrical substitution radiometer 201 to be sensitive to a broad range of wavelengths.

The broadband electrical substitution radiometer 201 includes an electrical thermometer-heater 207 disposed on the thermal isolation island 205. The electrical thermometer-heater 207 detects the change in temperature of the thermal isolation island 205 when the optical absorber 206 absorbs incident radiation. The electrical thermometer-heater 207 serves as the sensing element for electrical substitution radiometry and can be implemented using a platinum thin film or a metal oxide thermistor, which are deposited by processes such as sputtering and patterned using techniques such as photolithography and etching. The electrical thermometer-heater 207 provides a direct measure of incident radiation by both sensing the temperature change from the absorbed radiation and by heating the thermal isolation island 205 with electrical power. This dual functionality allows for absolute radiometric measurements.

The electrical lead 208 of the broadband electrical substitution radiometer 201 is in electrical communication with the electrical thermometer-heater 207. The electrical lead 208 receives the temperature signal from the electrical thermometer-heater 207 and provides the electrical power for heating the electrical thermometer-heater 207. The electrical lead 208 may be fabricated from a material such as platinum and deposited by sputtering. The electrical lead 208 enables both sensing of temperature and electrical heating of the electrical thermometer-heater 207, thus allowing the broadband electrical substitution radiometer 201 to perform absolute radiometry.

The catalyst layer 209 is disposed on the thermal isolation island 205 and is interposed between the support catalyst 210 and the optical absorber 206. The catalyst layer 209 is used for growth of the optical absorber 206 and may be, for example, a transition metal such as iron, cobalt, or nickel and deposited by sputtering. The catalyst layer 209 facilitates growth of the optical absorber 206 directly on the thermal isolation island 205, enabling efficient thermal transfer from the optical absorber 206 to the electrical thermometer-heater 207.

The broadband electrical substitution radiometer 201 can include a support catalyst 210 disposed on the thermal isolation island 205. The support catalyst 210 is interposed between the optical absorber 206 and the thermal isolation island 205 and deposited by sputtering. The support catalyst 210 enhances the growth of the optical absorber 206 and may be implemented, for example, as aluminum oxide. The support catalyst 210, being interposed between the optical absorber 206 and the thermal isolation island 205, facilitates growth of the optical absorber 206, thereby improving the performance of the broadband electrical substitution radiometer 201.

The broadband electrical substitution radiometer 201 may further include a diffusion barrier 211 disposed on the thermal isolation island 205. The diffusion barrier 211 is interposed between the electrical thermometer-heater 207 and the optical absorber 206 and limits diffusion between the electrical thermometer-heater 207 and the thermal isolation island 205 during fabrication. A suitable material for the diffusion barrier 211 is aluminum oxide, deposited using, for example, sputtering. The diffusion barrier 211, by limiting diffusion, prevents degradation of the electrical and thermal properties of both the electrical thermometer-heater 207 and the optical absorber 206, thus enhancing the performance of the broadband electrical substitution radiometer 201.

The broadband electrical substitution radiometer 201 may include an etch stop layer 212 on surface 202 of the substrate 214. The etch stop layer 212 prevents unwanted etching of the isolation layer 213 when removing the substrate 214 which may be removed with deep reactive ion etching (DRIE) or a KOH wet chemical etch, and may be a material such as silicon oxide. By preventing unwanted etching of the isolation layer 213, the etch stop layer 212 enables precise control of the dimensions of the thermal isolation support beam 204 and the thermal isolation island 205.

The isolation layer 213 of the broadband electrical substitution radiometer 201 is disposed on either the substrate 214 or the etch stop layer 212. The isolation layer 213 is a dielectric material, such as silicon nitride, and provides both thermal and electrical isolation between the substrate 214 and the ESR island 100. The isolation layer 213 is patterned to form the thermal isolation platform 203, the thermal isolation support beam 204, and the thermal isolation island 205. The isolation layer 213, being a dielectric, reduces thermal coupling and prevents electrical shorting between the substrate 214 and the electrical thermometer-heater 207, thereby enhancing the performance of the broadband electrical substitution radiometer 201.

The substrate 214 of the broadband electrical substitution radiometer 201 provides structural support for the other elements. The substrate 214 provides surface 202 and may comprise a silicon substrate. The substrate 214 may include an etch stop layer 212 disposed on the surface 202. The substrate 214 provides a stable, planar surface upon which other elements of the broadband electrical substitution radiometer 201 are disposed, thus enabling integration of the various components. The silicon substrate 214 is compatible with standard microfabrication processes such as reactive ion etching or wet chemical etching.

Although specific exemplary sizes and dimensions have been provided in the above description of the broadband electrical substitution radiometer 201, these dimensions are not required to practice all embodiments of the invention. The overall size of the broadband electrical substitution radiometer 201 may range from millimeters down to micrometers. Similarly, the thicknesses of the various layers may vary. The isolation layer 213, for example, may have a thickness ranging from tens of nanometers to micrometers. The width and length of the thermal isolation support beam 204, and the thermal isolation island 205, may also be varied, as can the height of the optical absorber 206. These variations in sizes and dimensions allow for flexibility in the design and implementation of the broadband electrical substitution radiometer 201 to meet specific application requirements. One skilled in the art will understand that the sizes and dimensions presented above for the broadband electrical substitution radiometer 201 are given for illustrative purposes only, and that other sizes and dimensions may be readily determined by a person having ordinary skill in the art.

While the thermal isolation island 205 is described as having a generally rectangular shape, this shape is not required to practice all embodiments of the invention. The thermal isolation island 205 may have other shapes, such as square, circular, or any other suitable shape. The shape of the thermal isolation support beam 204 may also vary to match that of the thermal isolation island 205. These variations in shape offer flexibility in the design and fabrication of the broadband electrical substitution radiometer 201 without affecting its functionality. Those skilled in the art will understand that the particular shapes described for the thermal isolation island 205 and the thermal isolation support beam 204 are for illustrative purposes only and that other suitable shapes for practicing the broadband electrical substitution radiometer 201 may be readily determined.

Although the above description recites certain materials for the various elements of the broadband electrical substitution radiometer 201, these specific materials are not required for practicing all embodiments of the invention. Other suitable materials may be substituted for the ones specifically mentioned above as being suitable for practicing the broadband electrical substitution radiometer. The substrate 214, for example, can be fabricated from materials other than silicon, such as semiconductor, glass, quartz, or a polymer. The isolation layer 213 may be any suitable dielectric material such as aluminum oxide, aluminum nitride, and silicon. The electrical thermometer-heater 207 may be any suitable material whose resistance varies with temperature, such as nickel, platinum, or a semiconductor. Similarly, a variety of materials may be used for the optical absorber 206. Carbon black, for example, can provide broadband absorption, as can a thin metal film deposited on a dielectric or a nano-structured thin film. Likewise, the electrical leads 208 may be implemented using any suitable conductive material. These various alternative materials offer flexibility in the design and fabrication of the broadband electrical substitution radiometer 201 while still achieving the desired functionality. One skilled in the art will understand that the materials described above for the broadband electrical substitution radiometer 201 are given by way of example and do not limit the scope of the present invention, and that other suitable materials may be readily determined by one skilled in the art. Elements of broadband electrical substitution radiometer array 200 can be made of a material that is physically or chemically resilient in an environment in which broadband electrical substitution radiometer array 200 is disposed. Exemplary materials include a metal, ceramic, thermoplastic, glass, semiconductor, and the like. The elements of broadband electrical substitution radiometer array 200 can be made of the same or different material and can be monolithic in a single physical body or can be separate members that are physically joined.

Broadband electrical substitution radiometer array 200 can be made in various ways. It should be appreciated that broadband electrical substitution radiometer array 200 includes a number of optical, electrical, or mechanical components, wherein such components can be interconnected and placed in communication (e.g., optical communication, electrical communication, mechanical communication, and the like) by physical, chemical, optical, or free-space interconnects. As a result, broadband electrical substitution radiometer array 200 can be disposed in a terrestrial environment or space environment. Elements of broadband electrical substitution radiometer array 200 can be formed from silicon, silicon nitride, and the like although other suitable materials, such ceramic, glass, or metal can be used. According to an embodiment, the elements of broadband electrical substitution radiometer array 200 are formed using 3D printing although the elements of broadband electrical substitution radiometer array 200 can be formed using other methods, such as injection molding or machining a stock material such as block of material that is subjected to removal of material such as by cutting, laser ablation, and the like. Accordingly, broadband electrical substitution radiometer array 200 can be made by additive or subtractive manufacturing. In an embodiment, elements of broadband electrical substitution radiometer array 200 are selectively etched to remove various different materials using different etchants and photolithographic masks and procedures. The various layers thus formed can be subjected to joining by bonding to form broadband electrical substitution radiometer array 200.

In an embodiment, a process for making a broadband electrical substitution radiometer 201 comprises: providing a substrate 214; depositing an isolation layer 213 on the substrate 214, the isolation layer 213 comprising a thermal isolation platform 203; patterning the isolation layer 213 to form a thermal isolation support beam 204 and a thermal isolation island 205; depositing an electrical thermometer-heater 207 on the thermal isolation island 205; patterning the electrical thermometer-heater 207; depositing an electrical lead 208 on the isolation layer 213; patterning the electrical lead 208; selective removal of the substrate 214 up to the etch stop layer 212; and depositing an optical absorber 206 on the thermal isolation island 205. In an embodiment, the isolation layer 213 is silicon nitride, and the depositing of the isolation layer 213 comprises low-pressure chemical vapor deposition. In an embodiment, the thermal isolation support beam 204 comprises four legs that support the thermal isolation island 205, and wherein the patterning of the isolation layer 213 comprises photolithography and etching. In an embodiment, the electrical thermometer-heater 207 is a platinum thin film, and the depositing of the electrical thermometer-heater 207 comprises sputtering. In an embodiment, the electrical thermometer-heater 207 is a metal oxide thermistor, and the depositing of the electrical thermometer-heater 207 comprises sputtering. In an embodiment, the depositing of the electrical lead 208 comprises sputtering. In an embodiment, the process further comprises depositing a diffusion barrier 211 on the thermal isolation island 205, the diffusion barrier 211 interposed between the electrical thermometer-heater 207 and the optical absorber 206. In an embodiment, the substrate 214 is selectively removed up to the etch stop layer 212 using deep reactive ion etching. In an embodiment, the optical absorber 206 is vertically aligned carbon nanotubes, and the depositing of the optical absorber 206 comprises chemical vapor deposition. In an embodiment, the process of further comprises: depositing a support catalyst 210 by sputtering on the thermal isolation island 205, the support catalyst 210 interposed between the optical absorber 206 and the thermal isolation island 205; and depositing a catalyst layer 209 by sputtering on the thermal isolation island 205, the catalyst layer 209 interposed between the support catalyst 210 and the optical absorber 206. In an embodiment, the substrate 214 comprises a silicon substrate 214.

The process for making a broadband electrical substitution radiometer 201 can start with providing a substrate 214 such as, for example, silicon. An isolation layer 213, such as silicon nitride, is then deposited on the substrate 214. The isolation layer 213 may be deposited using low-pressure chemical vapor deposition. The isolation layer 213 comprises a thermal isolation platform 203 that supports the thermal isolation support beam 204. The isolation layer 213 is patterned to define the thermal isolation support beam 204 and the thermal isolation island 205. The patterning may be accomplished using photolithography and etching. An electrical thermometer-heater 207 is deposited on the thermal isolation island 205. The electrical thermometer-heater 207 may be a material such as a platinum thin film. The platinum thin film may be deposited by sputtering. The electrical thermometer-heater 207 is patterned using, for example, photolithography and etching. An electrical lead 208 is deposited on the isolation layer 213 using a process such as sputtering. The electrical lead 208 may be fabricated from a material such as platinum. The electrical lead 208 is patterned using, for example, photolithography and etching. The substrate 214 is selectively removed up to the etch stop layer 212, for example, by photolithography and deep reactive ion etching. An optical absorber 206 is deposited on the thermal isolation island 205. The optical absorber 206 may be, for example, vertically aligned carbon nanotubes and deposited using chemical vapor deposition.

Providing a substrate 214 allows for a stable platform for the subsequent fabrication steps. Depositing an isolation layer 213 provides for both thermal and electrical isolation of the electrical thermometer-heater 207 from the substrate 214. Patterning the isolation layer 213 forms the thermal isolation support beam 204 and the thermal isolation island 205, which reduce thermal conduction and provide a location for the electrical thermometer-heater 207 and the optical absorber 206. The electrical thermometer-heater 207 provides for sensing temperature and controllable heating. The electrical lead 208 allows for electrical communication with the electrical thermometer-heater 207. Selective area removal of the substrate 214 behind the isolation layer 213 allows for creating a thermally isolated ESR island 100. The optical absorber 206 absorbs the incident radiation.

The isolation layer 213 may be silicon nitride. Low-pressure chemical vapor deposition of silicon nitride provides for a uniform, high-quality isolation layer 213. The thermal isolation support beam 204 may comprise a plurality of legs, e.g., two, three, four, or more legs. The legs are formed when the isolation layer 213 is patterned. The patterning of the isolation layer 213 may comprise photolithography and etching. The electrical thermometer-heater 207 may be a platinum thin film and deposited by sputtering. The electrical thermometer-heater 207 may alternatively be a metal oxide thermistor and deposited by sputtering. The electrical lead 208 may be deposited using sputtering. The process of fabricating the broadband electrical substitution radiometer 201 may further comprise depositing a diffusion barrier 211 on the thermal isolation island 205. The diffusion barrier 211 is interposed between the electrical thermometer-heater 207 and the optical absorber 206. The substrate 214 is selectively removed to form the ESR island 100. The optical absorber 206 may be implemented as vertically aligned carbon nanotubes deposited by chemical vapor deposition. The process for fabricating the broadband electrical substitution radiometer may further comprise depositing a support catalyst 210 on the thermal isolation island 205. The support catalyst 210 is interposed between the optical absorber 206 and the thermal isolation island 205. A catalyst layer 209 may be deposited on the thermal isolation island 205. The catalyst layer 209 is interposed between the support catalyst 210 and the optical absorber 206. The substrate 214 may be a silicon substrate 214.

Silicon nitride has excellent thermal and electrical isolation properties, and low-pressure chemical vapor deposition provides a suitable method for deposition. The thermal isolation support beam 204, comprising legs, limits thermal conduction. Photolithography and etching are well-suited for defining high-resolution features. Platinum provides a stable material for the electrical thermometer-heater 207 and can be deposited by sputtering. Metal oxide thermistors offer an alternative material for the electrical thermometer-heater 207 and are also readily deposited using sputtering. A diffusion barrier 211, for example aluminum oxide, limits diffusion between the electrical thermometer-heater 207 and the optical absorber 206. Deep reactive ion etching is well-suited for selective removal of the substrate 214, for example silicon. Vertically aligned carbon nanotubes are an excellent material for broadband absorption, and the use of a support catalyst 210 and a catalyst layer 209 can further improve the properties of the vertically aligned carbon nanotubes. Silicon is a readily available and low-cost material appropriate for use as a substrate 214.

The process for making a broadband electrical substitution radiometer 201 includes depositing an isolation layer 213 on the substrate 214. The isolation layer 213 may be, for example, silicon nitride and deposited by low-pressure chemical vapor deposition. Low-pressure chemical vapor deposition may be performed in a reaction chamber at a pressure of less than one atmosphere. A silicon-containing precursor gas, such as silane, and a nitrogen-containing precursor gas, such as ammonia, are introduced into the reaction chamber. The substrate 214 is heated to a temperature of, for example, 800° C. At this temperature, the precursor gases decompose, and silicon nitride deposits on the substrate 214.

After depositing the isolation layer 213 on the substrate 214, the isolation layer 213 is patterned to form a thermal isolation support beam 204 and a thermal isolation island 205. The patterning may comprise photolithography and etching. In the photolithography step, a photoresist layer is deposited on the isolation layer 213. The photoresist layer is exposed to ultraviolet light through a photomask that defines the shape of the thermal isolation support beam 204 and the thermal isolation island 205. After exposure, the photoresist is developed, removing the exposed regions and leaving behind a pattern in the photoresist. This pattern serves as a mask for subsequent etching. The etching step removes the exposed portions of the isolation layer 213, forming the thermal isolation support beam 204 and the thermal isolation island 205.

After patterning the isolation layer 213, an electrical thermometer-heater 207 is deposited on the thermal isolation island 205. The electrical thermometer-heater 207 may be implemented, for example, as a platinum thin film. The platinum thin film is deposited by sputtering. The sputtering process is performed in a vacuum chamber. The substrate 214, with the patterned isolation layer 213, is placed in the vacuum chamber, and a target of platinum is also placed in the chamber. An inert gas, such as argon, is introduced into the chamber, and a plasma is generated. The plasma ions bombard the platinum target, causing platinum atoms to be ejected from the target. The ejected platinum atoms then deposit onto the thermal isolation island 205, forming the platinum thin film.

After depositing the electrical thermometer-heater 207, the electrical thermometer-heater 207 is patterned to form the desired geometry. The patterning of the electrical thermometer-heater 207 may comprise photolithography and etching. A photoresist layer is deposited on the electrical thermometer-heater 207. The photoresist is then exposed to ultraviolet radiation through a photomask. The photomask defines the desired pattern for the electrical thermometer-heater 207. The exposed photoresist is developed, removing the exposed regions. The remaining photoresist serves as a mask for etching. The exposed electrical thermometer-heater 207 is then etched, leaving the patterned electrical thermometer-heater 207.

After patterning the electrical thermometer-heater 207, an electrical lead 208 is deposited on the isolation layer 213. The electrical lead 208 provides a conductive path for electrical communication with the electrical thermometer-heater 207. The electrical lead 208 may be a material such as platinum. The platinum is deposited by sputtering. The substrate 214 is placed in a vacuum chamber with a target of platinum. An inert gas, such as argon, is introduced into the chamber. A plasma is generated, and the plasma ions bombard the platinum target. The bombardment causes platinum atoms to be ejected from the target, and the ejected platinum atoms deposit onto the isolation layer 213, forming the electrical lead 208.

After depositing the electrical lead 208, the electrical lead 208 is patterned. The patterning may be performed using photolithography and etching. A photoresist layer is deposited on the electrical lead 208. The photoresist is exposed to ultraviolet light through a photomask, defining the desired pattern for the electrical lead 208. The exposed photoresist is developed to remove the exposed regions, leaving a photoresist pattern that serves as a mask for etching. The exposed electrical lead 208 is etched, forming the patterned electrical lead 208.

After patterning the electrical leads, the substrate 214 is patterned in alignment with ESR islands 100. The patterning may be performed using photolithography and deep reactive ion etching. The photoresist is exposed to ultraviolet light through a photomask, defining the areas of the substrate to be selectively removed behind the ESR island 100, leaving a photoresist pattern that serves as a mask for etching. The exposed substrate 214 is etched using deep reactive ion etching or wet chemical etching to selectively remove the volume; thereby creating a thermally isolated ESR island 100 and suspended isolation layer 213.

After patterning the electrical lead 208, an optical absorber 206 is deposited on the thermal isolation island 205. The optical absorber 206 may be, for example, vertically aligned carbon nanotubes. The vertically aligned carbon nanotubes are deposited using a chemical vapor deposition process. A carbon-containing precursor gas, such as acetylene, is introduced into a reaction chamber. The substrate 214, with the patterned isolation layer 213, the patterned electrical thermometer-heater 207, and the patterned electrical lead 208, is placed in the reaction chamber. The substrate 214 is heated to a temperature, for example 700-800° C., suitable for decomposing the precursor gas. The precursor gas decomposes, and carbon deposits on the thermal isolation island 205, forming the vertically aligned carbon nanotubes.

It is contemplated that broadband electrical substitution radiometer 201 can be fabricated according to the methods described in U.S. Pat. No. 9,291,499, the disclosure of which is incorporated by reference in its entirety.

In an embodiment, a process for performing electrical substitution radiometry with a broadband electrical substitution radiometer 201 comprising: providing the broadband electrical substitution radiometer 201 comprising: a substrate 214; an isolation layer 213 disposed on the substrate 214, the isolation layer 213 comprising a thermal isolation platform 203, a thermal isolation support beam 204, and a thermal isolation island 205; an electrical thermometer-heater 207 disposed on the thermal isolation island 205, the electrical thermometer-heater 207 for detecting a change in temperature of the thermal isolation island 205 and for controllably heating the thermal isolation island 205; an electrical lead 208 in electrical communication with the electrical thermometer-heater 207; selective removal of the substrate 214, and an optical absorber 206 disposed on the thermal isolation island 205 for absorbing radiation incident on the broadband electrical substitution radiometer 201; exposing the broadband electrical substitution radiometer 201 to radiation; electrically heating the electrical thermometer-heater 207 to a first temperature; detecting a change in temperature of the electrical thermometer-heater 207 in response to the radiation; and adjusting electrical power provided to the electrical thermometer-heater 207 to maintain the first temperature. In an embodiment, the isolation layer 213 is silicon nitride. In an embodiment, the thermal isolation support beam 204 comprises four legs that support the thermal isolation island 205. In an embodiment, the electrical thermometer-heater 207 is a platinum thin film. In an embodiment, the electrical thermometer-heater 207 is a metal oxide thermistor. In an embodiment, the process further comprising: placing the electrical thermometer-heater 207 in one arm of a Wheatstone bridge; and balancing the Wheatstone bridge at the first temperature. In an embodiment, the optical absorber 206 is vertically aligned carbon nanotubes. In an embodiment, the adjusting of electrical power comprises adjusting a pulse width modulated signal. In an embodiment, the substrate 214 comprises a silicon substrate 214. In an embodiment, the exposing of the broadband electrical substitution radiometer 201 comprises exposing to radiation in a wavelength range from 0.2 μm to 100 μm.

The process for performing electrical substitution radiometry includes providing the broadband electrical substitution radiometer 201. The broadband electrical substitution radiometer 201 comprises a substrate 214, an isolation layer 213, an electrical thermometer-heater 207, an electrical lead 208, and an optical absorber 206. The broadband electrical substitution radiometer 201 may include other elements such as a thermal isolation platform 203, a thermal isolation support beam 204, and a thermal isolation island 205. The broadband electrical substitution radiometer 201 is exposed to radiation. The radiation may be of any wavelength range including UV, visible, near-infrared, and infrared radiation. The electrical thermometer-heater 207 is electrically heated to a first temperature. The first temperature is chosen to be above the ambient temperature. The temperature of the electrical thermometer-heater 207 is sensed, for example, by placing it in one arm of a Wheatstone bridge. A change in temperature of the electrical thermometer-heater 207 in response to the incident radiation is detected. The amount of electrical power provided to the electrical thermometer-heater 207 is adjusted to maintain the first temperature. The adjustment of electrical power may be accomplished using a feedback loop.

The broadband electrical substitution radiometer 201 provides for broadband sensing and absolute radiometric measurements. Exposing the broadband electrical substitution radiometer 201 to radiation allows incident power to be measured. Heating the electrical thermometer-heater 207 to a known temperature establishes a baseline temperature, while detecting a temperature change from incident radiation provides the basis for the absolute power measurement. Adjusting the electrical power to maintain the first temperature allows a direct measurement of incident power.

The isolation layer 213 may be, for example, silicon nitride. The thermal isolation support beam 204 may comprise, for example, four legs. The electrical thermometer-heater 207 may be a platinum thin film. Alternatively, the electrical thermometer-heater 207 may be a metal oxide thermistor. The electrical thermometer-heater 207 may be placed in one arm of a Wheatstone bridge. The Wheatstone bridge is balanced at the first temperature. The optical absorber 206 may be implemented using vertically aligned carbon nanotubes to provide for broadband absorption of incident radiation. The electrical power provided to the electrical thermometer-heater 207 may be adjusted using a pulse width modulated signal. The substrate 214 may be, for example, silicon, allowing for selective removal using deep reactive ion etching to thermally isolate the ESR island 100. The broadband electrical substitution radiometer 201 may be exposed to radiation in a wavelength range from 0.2 μm to 100 μm.

Using silicon nitride as the isolation layer 213 provides good thermal and electrical isolation. Implementing the thermal isolation support beam 204 as separate legs reduces thermal conduction. Platinum provides good linearity and stability as a temperature sensor. Metal oxide thermistors offer another approach for sensing temperature and are compatible with microfabrication processing. Placing the electrical thermometer-heater 207 in a Wheatstone bridge offers a method for sensing changes in the electrical resistance of the electrical thermometer-heater 207. Balancing the Wheatstone bridge at the first temperature ensures that changes in the bridge signal are due to changes in incident radiation. Vertically aligned carbon nanotubes offer broadband absorption of radiation, extending from the ultraviolet to the far-infrared. A pulse width modulated signal enables precise control of the electrical power delivered to the electrical thermometer-heater 207. Silicon substrates are readily available and compatible with standard microfabrication processes such as deep reactive ion etching or KOH wet chemical etching. Broadband electrical substitution radiometry, employing the broadband electrical substitution radiometer 201, allows for a direct measure of incident power over a wide range of wavelengths.

The broadband electrical substitution radiometer 201 is exposed to radiation, allowing for radiation to be absorbed by the optical absorber 206. The radiation may be, for example, in the ultraviolet, visible, or infrared portion of the electromagnetic spectrum. The radiation may be focused onto the optical absorber 206 using a lens or mirror, or it may be unfocused, such as radiation from the ambient environment. The spectral content of the radiation may be broadband, covering a wide range of wavelengths, or it may be narrowband.

The electrical thermometer-heater 207 is electrically heated to a first temperature. The electrical thermometer-heater 207 is, for example, in one arm of a Wheatstone bridge. The remaining arms of the Wheatstone bridge may be comprised of fixed resistors. The first temperature is chosen such that the electrical thermometer-heater 207 is biased in a region where its resistance matches the resistors in the other arms of the Wheatstone bridge; thereby putting the Wheatstone bridge in balance. The electrical power provided to the electrical thermometer-heater 207 is adjusted to balance the Wheatstone bridge at the first temperature.

When the broadband electrical substitution radiometer 201 is exposed to radiation, a portion of the incident radiation is absorbed by the optical absorber 206, resulting in a change in temperature of the electrical thermometer-heater 207. This change in temperature is sensed as a change in the electrical resistance of the electrical thermometer-heater 207. For example, if the electrical thermometer-heater 207 is in one arm of a Wheatstone bridge, the temperature change results in a change in the voltage across the bridge.

The electrical power provided to the electrical thermometer-heater 207 is adjusted to maintain the first temperature. This adjustment may be performed, for example, using a pulse width modulated signal. The pulse width modulated signal controls the amount of current flowing through the electrical thermometer-heater 207. By adjusting the duty cycle of the pulse width modulated signal, the average power dissipated in the electrical thermometer-heater 207 can be adjusted. The power is adjusted so that the temperature of the electrical thermometer-heater 207 remains at the first temperature. The difference in power required to maintain the first temperature is equal to the power of the absorbed radiation. This equivalence enables direct measurement of the incident radiation power.

The electrical thermometer-heater 207 may be placed in one arm of a Wheatstone bridge. The Wheatstone bridge is an electrical circuit used to measure changes in resistance. The Wheatstone bridge comprises four resistors arranged in a diamond configuration. A voltage source is connected across two opposite vertices of the diamond, and a voltmeter is connected across the other two vertices. When the bridge is balanced, meaning that the ratio of the resistances in one pair of opposite arms is equal to the ratio of the resistances in the other pair, the voltage across the voltmeter is zero.

The Wheatstone bridge is balanced at the first temperature by adjusting the resistance of one of the other three arms of the bridge. For example, a variable resistor such as a metal thin film with a temperature dependent resistance (e.g. platinum) may be used for one of the arms, and its resistance may be adjusted until the voltage across the bridge is zero. Once the bridge is balanced, any change in the resistance of the electrical thermometer-heater 207, due to a change in incident radiation power, will cause a corresponding change in the bridge output voltage.

A pulse width modulated (PWM) signal may be used to adjust the electrical power provided to the electrical thermometer-heater 207. A PWM signal is a square wave whose duty cycle can be adjusted. The duty cycle is the percentage of time that the signal is high. By adjusting the duty cycle, the average power delivered to the electrical thermometer-heater 207 can be controlled. A feedback loop may be implemented in which the measured temperature of the electrical thermometer-heater 207 is compared to the first temperature, and the duty cycle of the PWM signal is adjusted to maintain the electrical thermometer-heater 207 at the first temperature.

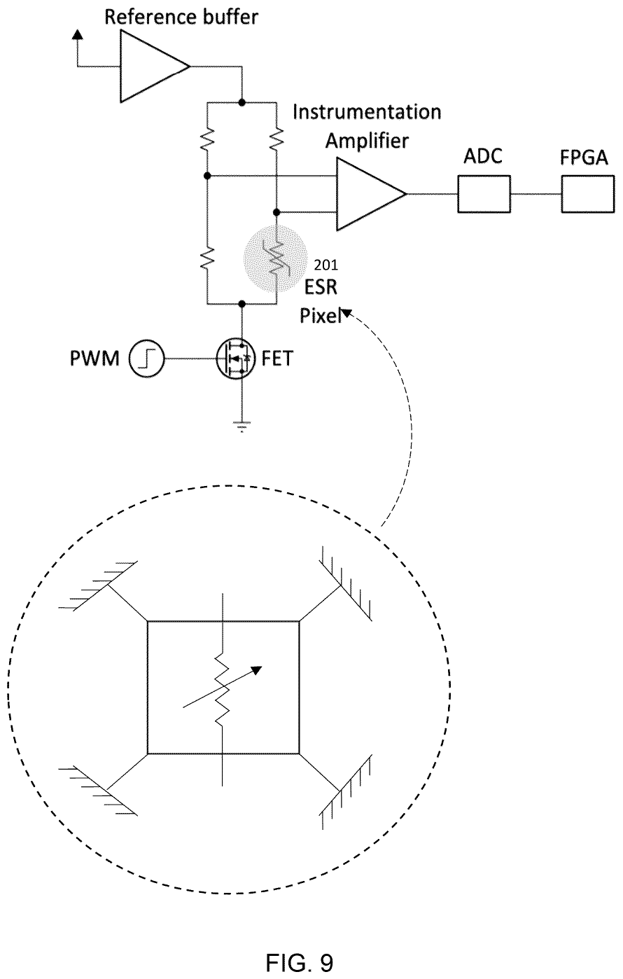

FIG. 9 shows an exemplary electronics configuration for operating a broadband electrical substitution radiometer 201. The electrical thermometer-heater 207 of the broadband electrical substitution radiometer 201 is shown in the schematic as a variable resistor. The electronics configuration comprises a Wheatstone bridge, a field effect transistor (FET), a pulse width modulation (PWM) generator, an instrumentation amplifier, an analog to digital converter (ADC), and a field programmable gate array (FPGA). The electrical thermometer-heater 207 is in one arm of the Wheatstone bridge. The Wheatstone bridge is biased with a reference voltage provided by a reference buffer. The remaining three arms of the Wheatstone bridge are fixed resistors. The output of the Wheatstone bridge is the input to the instrumentation amplifier. The output of the instrumentation amplifier is the input to the ADC, and the output of the ADC is the input to the FPGA. The output of the FPGA is the input to the PWM generator. The output of the PWM generator is the input to the gate of the FET. The drain of the FET is connected to the electrical thermometer-heater 207, and the source of the FET is connected to electrical ground. The reference buffer provides a stable voltage reference for the Wheatstone bridge and is implemented, for example, using an operational amplifier. The Wheatstone bridge is used to measure changes in the resistance of the electrical thermometer-heater 207. When the resistance of the electrical thermometer-heater 207 changes, the voltage at the output of the bridge also changes. The instrumentation amplifier amplifies the voltage change from the Wheatstone bridge, providing a larger voltage swing for the ADC. The ADC converts the analog signal from the instrumentation amplifier into a digital signal, and the FPGA uses the digital signal to generate the PWM signal. The PWM signal drives the gate of the FET. The FET acts as a switch, controlling the current flowing through the electrical thermometer-heater 207. When the gate voltage of the FET is high, the switch is closed, and current flows through the electrical thermometer-heater 207. When the gate voltage of the FET is low, the switch is open, and no current flows. The duty cycle of the PWM signal controls the average power delivered to the electrical thermometer-heater 207. The FPGA implements a feedback loop in which the power delivered to the electrical thermometer-heater 207 is adjusted to maintain the electrical thermometer-heater 207 at a constant temperature. The thermal isolation island 205, the electrical thermometer-heater 207, and the optical absorber 206 are components of an electrical substitution radiometer (ESR) island 100. The ESR island 100 is supported by a thermal isolation support beam 204. The thermal isolation support beam 204 is supported by a thermal isolation platform 203. The thermal isolation support beam 204 may be implemented as separate legs. The thermal isolation platform 203 is disposed on a substrate 214, which provides a surface 202. The substrate 214 beneath the thermal isolation platform 203 is selectively removed.

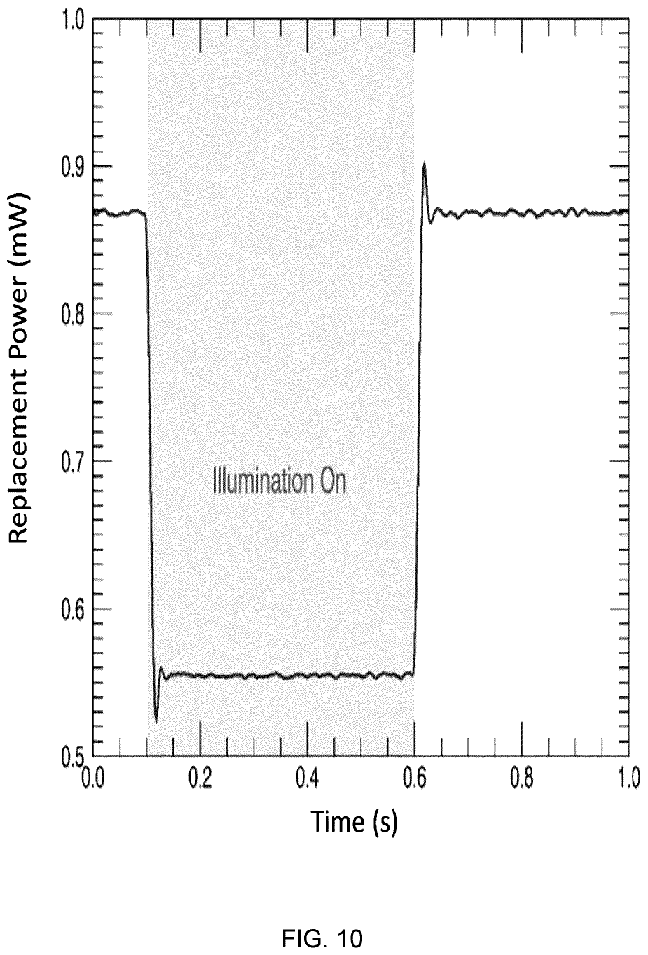

FIG. 10 shows data acquired from a broadband electrical substitution radiometer 201 using the electronics configuration of FIG. 9. The data plotted in FIG. 10 is the replacement power in milliwatts versus time in seconds, demonstrating electrical substitution radiometry with the broadband electrical substitution radiometer 201. The electrical thermometer-heater 207 of the broadband electrical substitution radiometer 201 is shown in the schematic as a resistor. The data in FIG. 10 shows the response of the broadband electrical substitution radiometer 201 to a change in incident radiation. The replacement power decreases when the broadband electrical substitution radiometer 201 is illuminated. The replacement power returns to its original value when the illumination is turned off. The difference in replacement power is a direct measure of the power incident on the broadband electrical substitution radiometer 201.

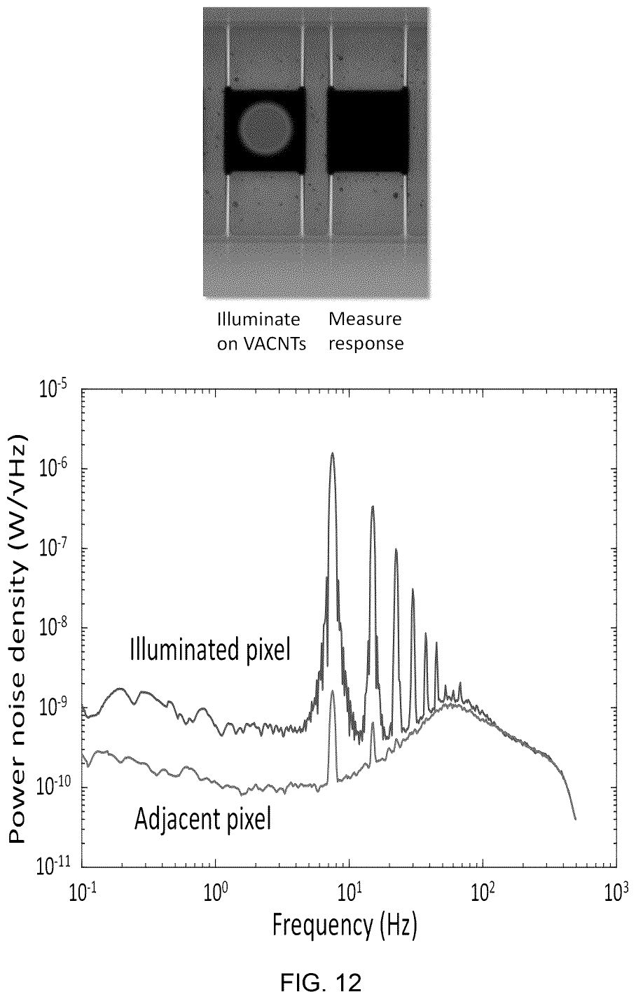

FIG. 12 shows the effect of thermal crosstalk on the performance of a broadband electrical substitution radiometer array 200. The top panel of FIG. 12 is a plan view of a portion of an array 200, showing two adjacent broadband electrical substitution radiometers 201, one of which (on the left) is illuminated with a laser. The bottom panel of FIG. 12 shows the power noise density as a function of frequency for both broadband electrical substitution radiometers 201, the upper blue curve for the illuminated broadband electrical substitution radiometer 201 and the lower orange curve for the broadband electrical substitution radiometer 201 that is not illuminated. The power noise density of the illuminated broadband electrical substitution radiometer 201 shows a response to the illuminating laser at a frequency of approximately 10 Hz. Each broadband electrical substitution radiometer 201 is separated from its adjacent broadband electrical substitution radiometers 201 by a distance of, e.g., 160 μm. The linear array of broadband electrical substitution radiometers 201 extends along a line. The broadband electrical substitution radiometers 201 are electrically isolated from each other. The plurality of broadband electrical substitution radiometers 201 are arranged in the linear array such that radiation incident on the array 200 is incident on the optical absorbers 206. The data in the bottom panel of FIG. 12 show that illuminating one broadband electrical substitution radiometer 201 with a modulated laser at a frequency of 10 Hz is independent to a response in an adjacent broadband electrical substitution radiometer 201. This is due to lack of thermal crosstalk between the adjacent broadband electrical substitution radiometers 201. Here, power noise density peaks for the non-illuminated broadband electrical substitution radiometers 201 is ascribed to spurious illumination derived from the vacuum chamber optical port in which the broadband electrical substitution radiometer array 200 was disposed instead of thermal stimulation from heating of the illuminated broadband electrical substitution radiometers 201.

The articles and processes herein are illustrated further by the following Example, which is non-limiting.

### Example

BABAR-ERI: Black Array of Broadband Absolute Radiometers-Earth Radiation Imager

BABAR-ERI is being developed for a CubeSat capable of imaging the Earth's outgoing longwave radiation with a 1 km ground sample distance (GSD) using a push-broom imager. The detector is a silicon micromachined 32-pixel linear array of electrical substitution radiometers capable of broadband sensing from 0.3 μm to 100 μm using vertically aligned carbon nanotube absorbers located on each pixel. Our aim is to demonstrate data performance, with a CubeSat, against existing CERES instruments but at a smaller GSD. Electrical substitution radiometers are well suited to this task as they have heritage as ground calibration transfer standards and in space for total solar irradiance measurements.

Data continuity for the Earth Radiation Budget Climate Data Record (ERB CDR) is currently maintained by six satellite instruments which are part of the Clouds and the Earth's Radiant Energy System (CERES) project. Each instrument consists of a three-channel scanning radiometer to monitor shortwave (0.2 μm-5 μm), thermal (8 μm-12 μm), and total (>0.2 μm) radiation emitted by the Earth with a ground sample distance of 10-20 km (depending on which CERES instrument). Updating and even continuing CERES poses a challenge as new or different instruments may not agree with CERES measurements. Introduction of new instruments will only be acceptable to the scientific community for the ERB CDR until proven alongside CERES. As a result, a parallel measurement of the Earth's radiance from top of atmosphere is required with low cost and risk. CubeSats fit the low cost/risk model having been readily adopted for technology demonstrations of new hardware in space. However, while CubeSats are ideally suited for simple working demonstrations of unproven or new technology, their low size, weight, and power (SWaP) requirements make it difficult to compete with data produced from conventional satellites instruments. Yet, two recent CubeSats, the Compact Spectral Irradiance Monitor (CSIM) and the Compact Total Irradiance Monitor (CTIM) have included new detector technology and have possible use in continuing the 40-year-old record of solar irradiance measurements from space currently maintained by TSIS-1 on the International Space Station. BABAR-ERI builds upon the relatively short but proven heritage of the CSIM and CTIM CubeSats. Both CSIM/CTIM instruments demonstrated that traditional active cavity radiometers used on TSIS-1 could be replaced with silicon micromachined electrical substitution radiometers (ESRs) with vertically aligned carbon nanotube absorbers (VACNTs) on a CubeSat. A similar measurement by the BABAR-ERI CubeSat coincident with CERES is required to demonstrate that a new detector can meet the accuracy and stability requirements of the CDR and possibly exceed them.

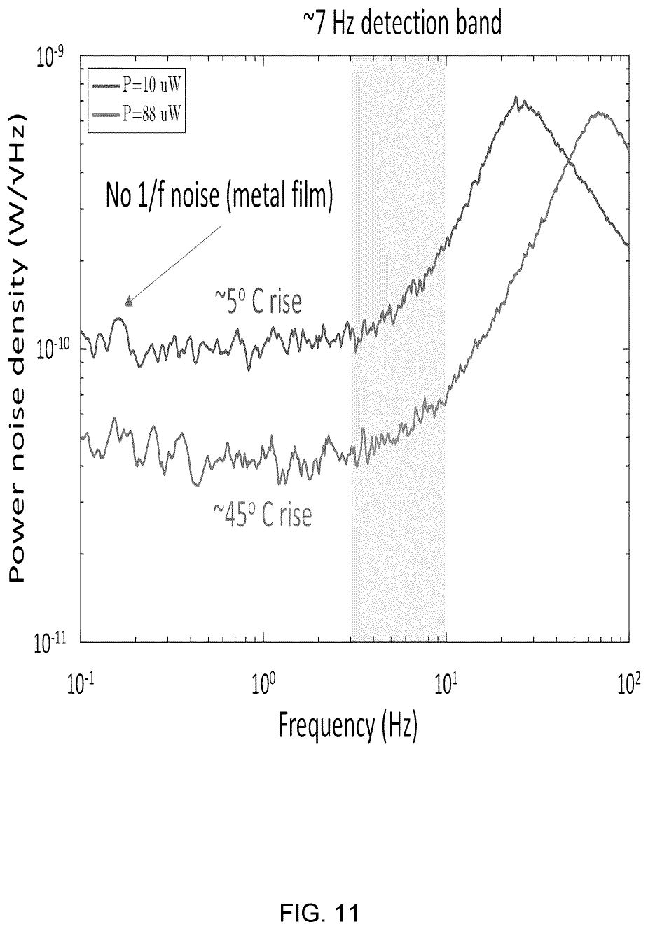

BABAR-ERI utilizes a MEMS array of ESRs with monolithic integration of all components. Each pixel is a 0.5 μm thick silicon nitride island (124 μm×124 μm) supported by four legs (0.5 μm×8 μm×100 μm). On the backside (non-illuminated) of each pixel, is a Pt wire with cross section of 0.2 μm×2 μm and approximately 1 kΩ in resistance. The frontside (illuminated) of each pixel is a VACNT absorber approximately 20 μm high. The two-wire Pt meander acts as both a thermistor (temperature coefficient of resistance=0.36%/° C.) and heater for electrical substitution operation. Platinum has been chosen for its known long-term stability in thermometry. Each pixel is placed within its own Wheatstone bridge and resistively self-heated by a pulse width modulation signal (PWM). Changes in optical power incident on the pixel are measured directly by monitoring the change in power applied by the PWM signal to keep the bridge in balance. Actively controlling the power balance of each pixel using replacement power heating allows us to achieve a closed-loop time constant of <10 ms (25 ms natural time constant). Optical power is coupled to each pixel through selective area growth of VACNTs on the frontside of each pixel (FIG. 6, FIG. 7, FIG. 8). VACNTs allow for broadband, far infrared absorption out to 100 μm. Measurements have confirmed that the reflectance of VACNTs is <1% from 0.3 μm to 100 μm. Power noise density measurements of a pixel are shown in FIG. 11. A replacement power of 88 μW (corresponding to a 45° C. pixel temperature rise) results in a noise floor of approximately 40 pW/√Hz. Operating the pixels at high replacement powers (>10 μW) allows for a larger dynamic range as well as a lower noise floor.

The BABAR-ERI CubeSat is a 12 U bus with two co-registered telescopes to measure the total (0.3 μm to 100 μm) and shortwave (0.3 μm to 4 μm) radiation. Longwave radiation will be determined by taking the difference of the two measured channels. Each detector channel will perform push-broom imaging of a 32-km wide swath with a 1 km footprint. A long-life chopping wheel (≈7 Hz) placed in front of both channels will allow for differential mode operation of the ESRs.

A unique aspect of BABAR-ERI is that it directly measures power incident, thereby eliminating the need for on-board radiometric calibration sources. Currently, active cavity radiometers are used in conjunction with on-board irradiance sources to calibrate detectors (e.g., bolometers). With the miniaturization of active cavity radiometers into a MEMS radiometer array, the Earth's radiance can be imaged directly.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

//PARTS LIST//

broadband electrical substitution radiometer array 200
broadband electrical substitution radiometer 201
electrical substitution radiometer (ESR) island 100
surface 202
thermal isolation platform 203
thermal isolation support beam 204
thermal isolation island 205
optical absorber 206
electrical thermometer-heater 207
electrical lead 208
catalyst layer 209
support catalyst 210
diffusion barrier 211
etch stop layer 212
isolation layer 213
substrate 214
performing electrical substitution radiometry

What is claimed is:

1. A broadband electrical substitution radiometer 201 comprising: a substrate 214; an isolation layer 213 disposed on the substrate 214, the isolation layer 213 comprising a thermal isolation platform 203, a thermal isolation support beam 204, and a thermal isolation island 205; an electrical thermometer-heater 207 disposed on the thermal isolation island 205, the electrical thermometer-heater 207 for detecting a change in temperature of the thermal isolation island 205 and for controllably heating the thermal isolation island 205; an electrical lead 208 in electrical communication with the electrical thermometer-heater 207; and an optical absorber 206 disposed on the thermal isolation island 205 for absorbing radiation incident on the broadband electrical substitution radiometer 201.

2. The broadband electrical substitution radiometer 201 of claim 1 wherein the isolation layer 213 is silicon nitride.

3. The broadband electrical substitution radiometer 201 of claim 1 wherein the thermal isolation support beam 204 comprises a plurality of legs that support the thermal isolation island 205.

4. The broadband electrical substitution radiometer 201 of claim 1 wherein the electrical thermometer-heater 207 is a platinum thin film.

5. The broadband electrical substitution radiometer 201 of claim 1 wherein the electrical thermometer-heater 207 is a metal oxide thermistor.

6. The broadband electrical substitution radiometer 201 of claim 1 further comprising a diffusion barrier 211 disposed on the thermal isolation island 205, the diffusion barrier 211 interposed between the electrical thermometer-heater 207 and the optical absorber 206.

7. The broadband electrical substitution radiometer 201 of claim 1 wherein the optical absorber 206 is vertically aligned carbon nanotubes.

8. The broadband electrical substitution radiometer 201 of claim 1 further comprising a support catalyst 210 disposed on the thermal isolation island 205, the support catalyst 210 interposed between the optical absorber 206 and the thermal isolation island 205.

9. The broadband electrical substitution radiometer 201 of claim 8 further comprising a catalyst layer 209 disposed on the thermal isolation island 205, the catalyst layer 209 interposed between the support catalyst 210 and the optical absorber 206.

10. The broadband electrical substitution radiometer 201 of claim 1 wherein the substrate 214 comprises a silicon substrate 214.

11. A broadband electrical substitution radiometer array 200 comprising: a plurality of broadband electrical substitution radiometers 201, each broadband electrical substitution radiometer 201 comprising: a substrate 214; an isolation layer 213 disposed on the substrate 214, the isolation layer 213 comprising a thermal isolation platform 203, a thermal isolation support beam 204, and a thermal isolation island 205; an electrical thermometer-heater 207 disposed on the thermal isolation island 205, the electrical thermometer-heater 207 for detecting a change in temperature of the thermal isolation island 205 and for controllably heating the thermal isolation island 205; an electrical lead 208 in electrical communication with the electrical thermometer-heater 207; and an optical absorber 206 disposed on the thermal isolation island 205 for absorbing radiation incident on the broadband electrical substitution radiometer 201, wherein each of the plurality of broadband electrical substitution radiometers 201 are arranged in a linear array.

12. The broadband electrical substitution radiometer array 200 of claim 11 wherein the isolation layer 213 is silicon nitride.

13. The broadband electrical substitution radiometer array 200 of claim 11 wherein the thermal isolation support beam 204 comprises a plurality of legs that support the thermal isolation island 205.

14. The broadband electrical substitution radiometer array 200 of claim 11 wherein the electrical thermometer-heater 207 is a platinum thin film.

15. The broadband electrical substitution radiometer array 200 of claim 11 wherein the electrical thermometer-heater 207 is a metal oxide thermistor.

16. The broadband electrical substitution radiometer array 200 of claim 11 further comprising a diffusion barrier 211 disposed on the thermal isolation island 205, the diffusion barrier 211 interposed between the electrical thermometer-heater 207 and the optical absorber 206.

17. The broadband electrical substitution radiometer array 200 of claim 11 wherein the optical absorber 206 is vertically aligned carbon nanotubes.

18. The broadband electrical substitution radiometer array 200 of claim 11 further comprising a support catalyst 210 disposed on the thermal isolation island 205, the support catalyst 210 interposed between the optical absorber 206 and the thermal isolation island 205.

19. The broadband electrical substitution radiometer array 200 of claim 18 further comprising a catalyst layer 209 disposed on the thermal isolation island 205, the catalyst layer 209 interposed between the support catalyst 210 and the optical absorber 206.

20. The broadband electrical substitution radiometer array 200 of claim 11 wherein the substrate 214 comprises a silicon substrate 214.

21. A process for performing electrical substitution radiometry with a broadband electrical substitution radiometer 201 comprising: providing the broadband electrical substitution radiometer 201 comprising: a substrate 214; an isolation layer 213 disposed on the substrate 214, the isolation layer 213 comprising a thermal isolation platform 203, a thermal isolation support beam 204, and a thermal isolation island 205; an electrical thermometer-heater 207 disposed on the thermal isolation island 205, the electrical thermometer-heater 207 for detecting a change in temperature of the thermal isolation island 205 and for controllably heating the thermal isolation island 205; an electrical lead 208 in electrical communication with the electrical thermometer-heater 207; selective removing the substrate 214 to form a suspended isolation layer 213; and an optical absorber 206 disposed on the thermal isolation island 205 for absorbing radiation incident on the broadband electrical substitution radiometer 201; exposing the broadband electrical substitution radiometer 201 to radiation; electrically heating the electrical thermometer-heater 207 to a first temperature; detecting a change in temperature of the electrical thermometer-heater 207 in response to the radiation; and adjusting electrical power provided to the electrical thermometer-heater 207 to maintain the first temperature.

22. The process of claim 21 wherein the isolation layer 213 is silicon nitride.

23. The process of claim 21 wherein the thermal isolation support beam 204 comprises four legs that support the thermal isolation island 205.

24. The process of claim 21 wherein the electrical thermometer-heater 207 is a platinum thin film.

25. The process of claim 21 wherein the electrical thermometer-heater 207 is a metal oxide thermistor.

26. The process of claim 21 further comprising: placing the electrical thermometer-heater 207 in one arm of a Wheatstone bridge; and balancing the Wheatstone bridge at the first temperature.

27. The process of claim 21 wherein the optical absorber 206 is vertically aligned carbon nanotubes.

28. The process of claim 21 wherein the adjusting of electrical power comprises adjusting a pulse width modulated signal.

29. The process of claim 21 wherein the substrate 214 comprises a silicon substrate 214.

30. The process of claim 21 wherein the exposing of the broadband electrical substitution radiometer 201 comprises exposing to radiation in a wavelength range from 0.2 μm to 100 μm.
